(19) United States
(12) Patent Application Publication
(10) Pub. No.: US 2024/0393721 A1
(43) Pub. Date: Nov. 28, 2024

(54) IMAGE FORMING SYSTEM

(71) Applicant: FUJIFILM Business Innovation Corp., Tokyo (JP)

(72) Inventors: Masaaki YAMAURA, Kanagawa (JP); Toshihiko MITSUHASHI, Kanagawa (JP); Mariko SUZUKI, Kanagawa (JP); Akihiro TAKAHASHI, Kanagawa (JP)

(73) Assignee: FUJIFILM Business Innovation Corp., Tokyo (JP)

(21) Appl. No.: 18/512,998

(22) Filed: Nov. 17, 2023

(30) Foreign Application Priority Data
May 23, 2023 (JP) 2023-084903

(51) Int. Cl. G03G 15/00

(52) U.S. Cl. CPC G03G 15/50

(57) ABSTRACT

An image forming system includes: an image carrying element that is rotatably provided and carries an image; an image forming element that forms the image on the image carrying element using an image forming material containing at least an external additive; a transfer element that transfers the image carried by the image carrying element to a medium; a cleaning element having a plate shape, the cleaning element being disposed so that a leading end comes into contact with the image carrying element while being inclined in a direction opposite to a rotation direction of the image carrying element to clean a residue remaining on the image carrying element after a transfer operation by the transfer element; a maintenance element that forms, using the image forming element, a band-shaped maintenance image of the image forming material in a non-image formation region of the image carrying element, and regularly or irregularly supplies the maintenance image to the cleaning element in a state where the transfer operation by the transfer element is not performed; a microparticle application element that regularly or irregularly applies a microparticle having lubricity to the image carrying element; and a maintenance control element that controls an amount of the maintenance image by the maintenance element depending on an application state of the microparticle on the image carrying element.

### CROSS-REFERENCE TO RELATED APPLICATIONS

This application is based on and claims priority under 35 USC 119 from Japanese Patent Application No. 2023-084903 filed May 23, 2023.

### BACKGROUND

### (i) Technical Field

The present invention relates to an image forming system.

### (ii) Related Art

Conventionally, devices disclosed in JP2006-313377A, JP2000-259011A, and JP2001-175090A, for example, are already known as this type of image forming system.

JP2006-313377A discloses an image forming device including an image carrier having a surface on which a toner image is formed, an intermediate transfer member that receives the toner image transferred from the image carrier and then transfers the toner image next, and a microparticle attaching device that attaches microparticles to the surface of the intermediate transfer member. The microparticle attaching device has a rotating brush and a rod member for brushing off excess microparticles, the rod member being supported so that the end of the bristle of the rotating brush is brought into contact with the rod member and the rod member is parallel to the rotating brush.

FIG. 1 of JP2000-259011A discloses an image recording device including an intermediate transfer member 5a in contact with image carriers 1K and 1Y, an intermediate transfer member 5b in contact with image carriers 1M and 1C, an intermediate transfer member 6 in contact with the intermediate transfer members 5a and 5b, and microparticle attachment devices 20a, 20b, and 20c for attaching microparticles having an average particle diameter three times or less the average particle diameter of primary particles to the surfaces of the intermediate transfer members 5a, 5b, and 6.

JP2001-175090A discloses an image forming device including a control means for executing control to form a toner band (band-shaped toner image) crossing a specified region in the specified region which is at least a region not facing a recording sheet and outside a side end of the recording sheet in a feeding direction of the recording sheet in a transferable region of an intermediate transfer belt, when the width of the recording sheet in the feeding direction is narrower than a prescribed determination reference value.

### SUMMARY

Aspects of non-limiting embodiments of the present disclosure relate to an image forming system which can realize a maintenance process for a plate-shaped cleaning element without wastefully consuming an image forming material in a mode in which microparticles can be applied to an image carrying element.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system comprising: an image carrying element that is rotatably provided and carries an image; an image forming element that forms the image on the image carrying element using an image forming material containing at least an external additive; a transfer element that transfers the image carried by the image carrying element to a medium; a cleaning element having a plate shape, the cleaning element being disposed so that a leading end comes into contact with the image carrying element while being inclined in a direction opposite to a rotation direction of the image carrying element to clean a residue remaining on the image carrying element after a transfer operation by the transfer element; a maintenance element that forms, using the image forming element, a band-shaped maintenance image of the image forming material in a non-image formation region of the image carrying element, and regularly or irregularly supplies the maintenance image to the cleaning element in a state where the transfer operation by the transfer element is not performed; a microparticle application element that regularly or irregularly applies a microparticle having lubricity to the image carrying element; and a maintenance control element that controls an amount of the maintenance image by the maintenance element depending on an application state of the microparticle on the image carrying element.

### BRIEF DESCRIPTION OF THE DRAWINGS

FIG. 1 is an explanatory diagram illustrating an overview of an embodiment of an image forming system to which the present invention is applied.

FIG. 2A is an explanatory diagram illustrating examples of an image and a maintenance image formed on an image carrying means, FIG. 2B is an explanatory diagram illustrating states of a surface of the image carrying means and the image in a transfer region when a normal medium is used, FIG. 2C is an explanatory diagram illustrating states of the surface of the image carrying means and the image in the transfer region when an embossed medium is used, FIG. 2D is an explanatory diagram illustrating an example of the maintenance image in a cleaning region when microparticles are not applied onto the image carrying means, and FIG. 2E is an explanatory diagram illustrating an example of the maintenance image in the cleaning region when microparticles are applied onto the image carrying means.

FIG. 3 is an explanatory diagram illustrating an overall configuration of an image forming system according to a first embodiment.

FIG. 4A is an explanatory diagram illustrating the details of an image forming unit in FIG. 3, and FIG. 4B is an explanatory diagram illustrating the details of an intermediate-transfer-member cleaning device in FIG. 3.

FIG. 5A is an explanatory diagram illustrating a main part of a cleaning member of the intermediate-transfer-member cleaning device, FIG. 5B is an explanatory diagram illustrating a preferable state of the cleaning member indicated by B in FIG. 5A, and FIG. 5C is an explanatory diagram illustrating a state in which a maintenance process of the cleaning member is needed.

FIG. 6A is an explanatory diagram illustrating details of a transfer device, FIG. 6B is an explanatory diagram schematically illustrating a transfer operation in a normal image forming mode indicated by B in FIG. 6A, and FIG. 6C is an explanatory diagram schematically illustrating a transfer operation in a special image forming mode.

FIG. 7A is an explanatory diagram illustrating an example of a microparticle application device used in the first embodiment, FIG. 7B is an explanatory diagram illustrating a state of the microparticle application device at the end of an image forming operation, and FIG. 7C is an explanatory diagram illustrating a state of the microparticle application device at the start of supply of microparticles.

FIG. 8A is an explanatory diagram conceptually illustrating an operation of applying the microparticles to an intermediate transfer member by the microparticle application device, and FIG. 8B is an explanatory diagram schematically illustrating the principle of applying the microparticles to the intermediate transfer member by an application roller illustrated in FIG. 8A.

FIG. 9A is an explanatory diagram illustrating an arrangement example of an optical sensor for detecting an application state of the microparticles on the intermediate transfer member, FIG. 9B is a diagram viewed from a direction of B in FIG. 9A, FIG. 9C is an explanatory diagram illustrating a detection state of the optical sensor in a situation where microparticles are not applied onto the intermediate transfer member, FIG. 9D is an explanatory diagram illustrating a detection state of the optical sensor in a situation where microparticles are applied on the intermediate transfer member, and FIG. 9E is an explanatory diagram illustrating an example of a relationship between a microparticle coverage on the intermediate transfer member and an output of the optical sensor.

FIG. 10A is a graph illustrating a relationship between the microparticle coverage on the intermediate transfer member and a toner adhesion force, FIG. 10B is an explanatory diagram schematically illustrating a relationship between a microparticle application amount on the intermediate transfer member and a toner adhesion amount, and FIG. 10C is an explanatory diagram illustrating a relationship between a transfer bias and the image quality depending on whether the microparticles are applied or not.

FIG. 11 is an explanatory diagram illustrating a control system of the image forming system according to the first embodiment.

FIG. 12 is a flowchart illustrating an example of a process of microparticle application control used in the first embodiment.

FIG. 13 is a flowchart illustrating an example of a process of maintenance control of a cleaning device used in the first embodiment.

FIG. 14A is an explanatory diagram schematically illustrating an example of a normal image forming mode, FIG. 14B is an explanatory sectional view taken along line B-B in FIG. 14A, FIG. 14C is an explanatory diagram schematically illustrating an example of a special image forming mode, and FIG. 14D is an explanatory sectional view taken along line D-D in FIG. 14C.

FIG. 15A is an explanatory diagram schematically illustrating an example of a normal maintenance mode (maintenance mode I), FIG. 15B is an explanatory sectional view taken along line B-B in FIG. 15A, FIG. 15C is an explanatory diagram schematically illustrating another example of a special maintenance mode (maintenance mode II), FIG. 15D is an explanatory sectional view taken along line D-D in FIG. 15C, and FIG. 15E is an explanatory diagram illustrating another example of the maintenance mode II.

FIG. 16A is an explanatory diagram schematically illustrating a maintenance operation in the maintenance mode I, and FIG. 16B is an explanatory diagram schematically illustrating the maintenance operation in the maintenance mode II.

FIG. 17 is an explanatory diagram illustrating a modification 1-1 of the microparticle application device used in the first embodiment.

FIG. 18 is an explanatory diagram illustrating a modification 1-2 of the microparticle application device used in the first embodiment.

FIG. 19 is a flowchart illustrating an example of a process of microparticle application control used in an image forming system according to a second embodiment.

FIG. 20 is a flowchart illustrating an example of a process of maintenance control of an intermediate-transfer-member cleaning device used in the second embodiment.

FIG. 21 is an explanatory diagram illustrating an example of a maintenance operation of the intermediate-transfer-member cleaning device used in the second embodiment.

FIG. 22 is an explanatory diagram illustrating a main part of an image forming system according to a third embodiment.

FIG. 23 is a table illustrating a relationship between a maintenance image and an application state of microparticles for evaluating the cleaning performance of the intermediate-transfer-member cleaning device.

FIG. 24 is a graph illustrating a relationship between the particle diameter of microparticles of a microparticle application layer and the adhesion force of toner to the intermediate transfer member.

FIG. 25 is a graph illustrating a relationship between the toner adhesion force to the intermediate transfer member and transferability grade.

FIG. 26 is a table illustrating a relationship between a maintenance image and the particle diameter of microparticles of the microparticle application layer for evaluating the cleaning performance of the intermediate-transfer-member cleaning device.

### DETAILED DESCRIPTION

### ⊙ Overview of Embodiments

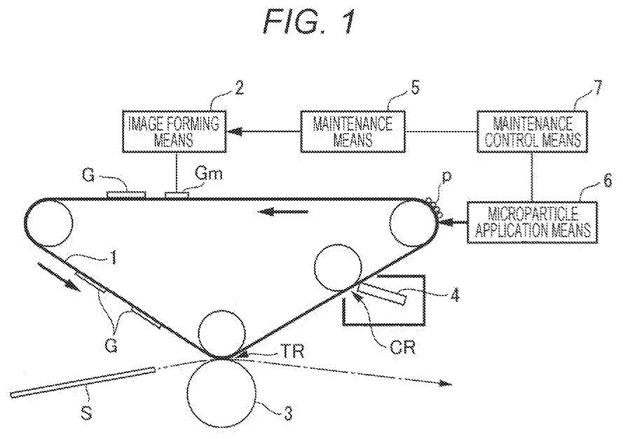

FIG. 1 illustrates an overview of an embodiment of an image forming system to which the present invention is applied.

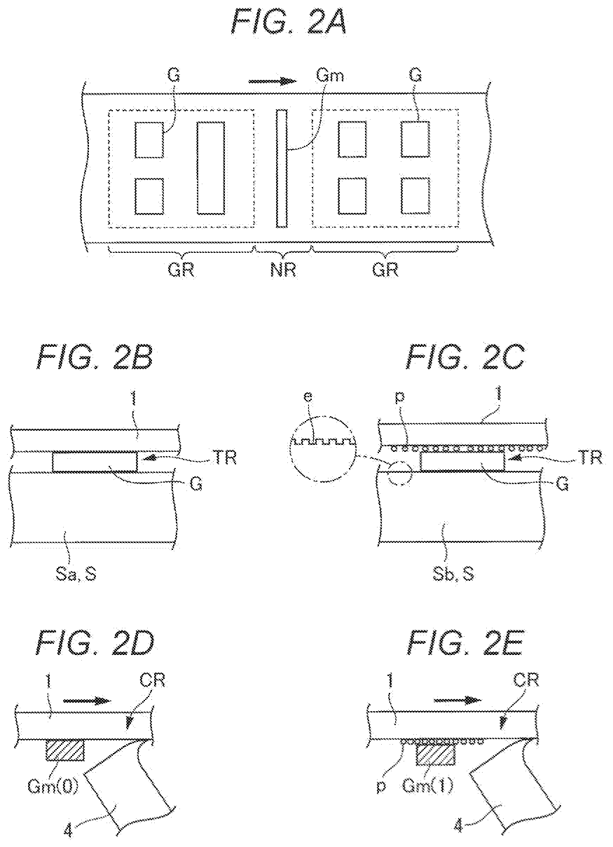

In FIG. 1, the image forming system includes: an image carrying means 1 that is rotatably provided and carries an image G; an image forming means 2 that forms the image G on the image carrying means 1 using an image forming material containing at least an external additive; a transfer means 3 that transfers the image G carried by the image carrying means 1 to a medium S; a cleaning means 4 having a plate shape, the cleaning means 4 being disposed so that a leading end comes into contact with the image carrying means 1 while being inclined in a direction opposite to a rotation direction of the image carrying means 1 to clean a residue remaining on the image carrying means 1 after a transfer operation by the transfer means 3; a maintenance means 5 that forms, using the image forming means 2, a band-shaped maintenance image Gm of the image forming material in a non-image formation region NR (refer to FIG. 2A) of the image carrying means 1, and regularly or irregularly supplies the maintenance image Gm to the cleaning means 4 in a state where the transfer operation by the transfer means 3 is not performed; a microparticle application means 6 that regularly or irregularly applies a microparticle p having lubricity to the image carrying means 1; and a maintenance control means 7 that controls an amount of the maintenance image by the maintenance means 5 depending on an application state of the microparticle p on the image carrying means 1.

In such a technical aspect, the “image forming system” in the present application is not limited to a system constituted by a single device, but includes a system constituted by a plurality of devices.

The image carrying means 1 may be of any type that carries the image G formed by the image forming means, and may be an image forming and carrying means such as a photoconductor or a dielectric that directly forms and carries the image G, or may be an intermediate transfer means that intermediately carries the image G formed by the image forming and carrying means before the image G is transferred to the medium S.

In addition, the image forming means 2 is not limited to an electrophotographic type, and includes various types such as an electrostatic recording type using an ion flow as long as it forms an image using an image forming material containing at least an external additive.

Furthermore, the transfer means 3 may be appropriately selected as long as it transfers the image G carried on the image carrying means 1 to the medium S, and a mode of transferring an image under pressure using a transfer electric field is typical.

Furthermore, any type of the cleaning means 4 may be appropriately selected as long as it uses a mode (so-called blade cleaning system) in which a leading end of an elastic plate-shaped member is in contact with the image carrying means 1 in a state of being inclined in a direction opposite to the rotation direction of the image carrying means 1.

In addition, the “band-shaped maintenance image Gm” by the maintenance means 5 may be one or a plurality of band-shaped images continuously extending along the width direction (corresponding to the intersecting direction intersecting with the rotation direction of the image carrying means 1) of the image formation region (corresponding to an image forming region) GR (see FIG. 2A) of the image carrying means 1, or may be a band-shaped image that discontinuously extends. Regarding the execution timing of maintenance operation by the maintenance means 5, the maintenance operation may be executed regularly from the viewpoint of preventing the leading end of the cleaning means 4 from being turned up or worn, or may be irregularly executed by determining the maintenance timing from an image forming condition or the like by the image forming means 2.

Further, a medium having various physical properties may be appropriately selected as the medium S. For example, in a case where a normal medium Sa such as plain paper is used as the medium S, the surface of the normal medium Sa is substantially smooth as illustrated in FIG. 2B, so that the image G on the image carrying means 1 is easily transferred onto the normal medium Sa by a transfer electric field in the transfer region TR, and thus, a transfer failure is unlikely to occur. On the other hand, in a case where, for example, an embossed medium Sb is used as the medium S, the transferability of the image G on the image carrying means 1 tends to decrease due to the influence of the surface roughness (embossed surface) e of the embossed medium Sb as illustrated in FIG. 2C. This is because the image G is less likely to be transferred to recessed portions than to protruding portions of the surface roughness e of the embossed medium Sb. In the present embodiment, in order to avoid such a situation, the microparticle application means 6 applies the microparticles p having lubricity onto the image carrying means 1 to improve the transferability of the image G when the embossed medium Sb is used. The “microparticle p” used herein may be appropriately selected as long as it has lubricity. If the external additive contained in the image forming material 2 of the image forming means 2 has lubricity, a material similar to the external additive can be used as the microparticle p, or a material different from the external additive may be used.

Furthermore, the maintenance control means 7 controls the maintenance operation of the maintenance means 5 in view of the application state of the microparticles p by the microparticle application means 6 (whether or not the microparticles p are applied or an application amount of microparticles p).

For example, when the microparticles p are not applied to the image carrying means 1, a normal maintenance image Gm(0) may be produced as the maintenance image Gm using a normal amount of the image forming material, and the maintenance image Gm(0) may be supplied to a cleaning region CR at the leading end of the cleaning means 4 as illustrated in FIG. 2D. In contrast, when, for example, the image carrying means 1 is applied with the microparticles p, the fact that a layer of the applied microparticles p functions as a part of the maintenance image Gm is focused. Specifically, as illustrated in FIG. 2E, a special maintenance image Gm(1) which is smaller in amount than the normal maintenance image Gm(0) is generated as the maintenance image Gm, and the special maintenance image Gm(1) may be supplied together with the layer of microparticles p to the cleaning region CR at the leading end of the cleaning means 4.

Next, a representative aspect or a preferable aspect of the image forming system according to the present embodiment will be described.

First, as a representative aspect of the maintenance control means 7, there is an aspect of controlling an amount of the maintenance image by the maintenance means 5 (an amount of the image forming material used for producing the maintenance image Gm) to be different between under the condition that the microparticles p are applied and under the condition that the microparticles p are not applied, with an amount of the maintenance image by the maintenance means 5 under the condition that the microparticles p are not applied being defined as an upper limit. In this aspect, an amount of the maintenance image is changed depending on whether or not the microparticles p are applied.

Here, the reason why “an amount of the maintenance image by the maintenance means 5 under the condition that the microparticles p are not applied” is defined “as an upper limit” is to clearly exclude a mode in which an amount of the maintenance image is larger when the microparticles p are applied than when the microparticles p are not applied.

As a specific example of this aspect, there is an aspect of controlling an amount of the maintenance image to be smaller under a condition that the microparticles p are applied than under a condition that the microparticles p are not applied. In addition, in a case where the application amount of the microparticles p is sufficiently large, it is also possible to perform control such that the special maintenance image Gm(1) is not supplied under the condition that the microparticles p are applied.

As another representative aspect of the maintenance control means 7, there is an aspect of performing control so that an amount of the maintenance image varies depending on the application amount of the microparticles p under the condition that the microparticles p are applied, with an amount of the maintenance image by the maintenance means 5 under the condition that the microparticles p are not applied being defined as an upper limit. In this aspect, an amount of the maintenance image is varied depending on an application amount of the microparticles p.

Specific examples of this aspect include an aspect of controlling an amount of the maintenance image to be smaller as the application amount of the microparticles p is greater under a condition that the microparticles p are applied and an aspect of controlling an amount of the maintenance image to be greater as the application amount of the microparticles p is smaller under a condition that the microparticles p are applied.

In addition, as a preferable aspect of the maintenance control means 7, there is an aspect in which a detection means (not illustrated) capable of detecting an application state of the microparticles p is provided and the amount of the maintenance image is controlled on the basis of a detection result of the detection means. In this aspect, the application state of the microparticles p is detected by the detection means, and an amount of the maintenance image appropriate for the application state of the microparticles p is selected.

In this aspect, the detection means may be constituted by a reflective optical sensor disposed so as to face the application layer of the microparticles p.

In addition, as a preferable aspect of the microparticle application means 6, there is an aspect in which the microparticles p having a particle diameter in a range of 30 nm to 150 nm are applied to the image carrying means 1 having a surface roughness Rz of 1.5 or less or a microgloss of 93 or more. In this aspect, from the viewpoint of reducing the adhesion force of the image G on the image carrying means 1 when the embossed medium Sb is used, an appropriate range is selected for the surface property of the image carrying means 1 and the particle diameter of the microparticles p.

In this aspect, the microparticle application means 6 may apply the microparticles p on the image carrying means 1 at a coverage of 10% to 50%. In this aspect, a preferable coverage of the microparticles p is selected in consideration of the fact that, even if the microparticles p are applied to the image carrying means 1 with a coverage of more than 50%, the adhesion force of the image G on the image carrying means 1 is not significantly reduced as compared with the case where the coverage is 50% or less.

Embodiments of the present invention will be described below in more detail with reference to the accompanying drawings.

### ⊙ First Embodiment

### —Overall Configuration of Image Forming System—

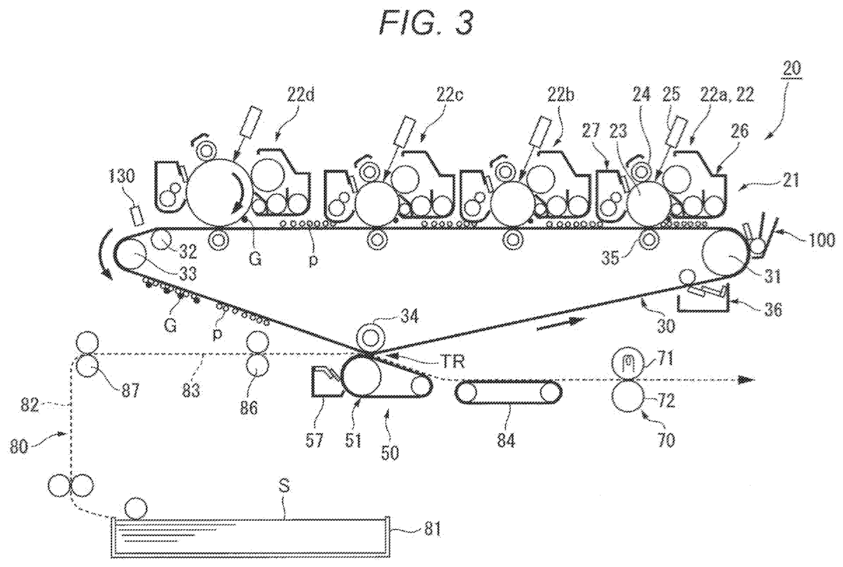

FIG. 3 illustrates the overall configuration of an image forming system according to a first embodiment.

In FIG. 3, an image forming system 20 is mounted in a device housing not illustrated, and includes an image forming engine 21 for forming images of a plurality of color components (four colors of yellow (Y), magenta (M), cyan (C), and black (K) in the present embodiment), a transfer device 50 for transferring the color component images formed by the image forming engine 21 onto a medium S, a fixing device 70 for fixing the color component images transferred in a transfer region TR of the transfer device 50 onto the medium S, and a medium conveyance system 80 for conveying the medium S to the transfer region TR of the transfer device 50.

### Configuration Example of Image Forming Engine

In the present embodiment, the image forming engine 21 includes image forming units 22 (to be specific, 22a to 22d) that form images of a plurality of color components, and a belt-shaped intermediate transfer member 30 that sequentially transfers (primary transfer) images G of the color components formed by the image forming units 22, carries the images G, and conveys the images G to a transfer section where the images G are transferred to the medium S.

### <Image Forming Unit>

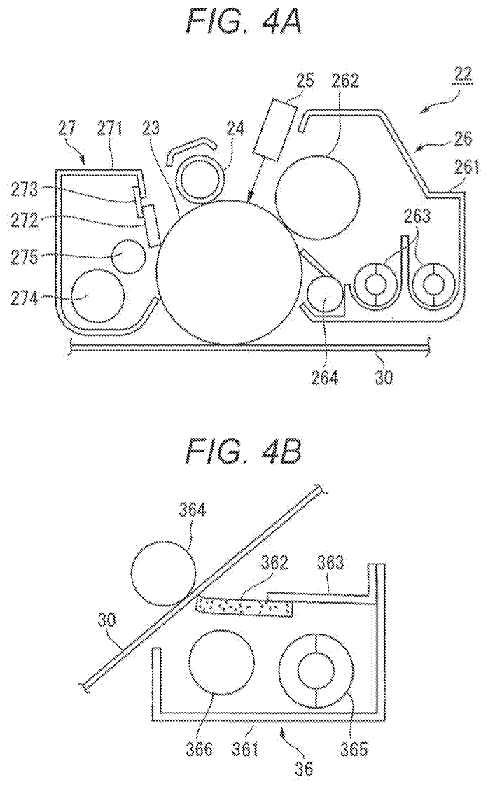

In the present embodiment, each of the image forming units 22 (22a to 22d) employs, for example, an electrophotographic system and includes a drum-shaped photoconductor 23 as illustrated in FIGS. 3 and 4. Each of the image forming units 22 includes, around the photoconductor 23, a charging device 24 that charges the photoconductor 23, an optical writing device 25 that writes an electrostatic latent image on the charged photoconductor 23, a developing device 26 that develops the electrostatic latent image written on the photoconductor 23 with toner of each color component, and a photoconductor cleaning device 27 that removes toner remaining on the photoconductor 23 after an image is transferred to the intermediate transfer member 30.

Although a charging roller, for example, is used as the charging device 24 in the present embodiment, a corotron, a scorotron, or the like may be appropriately selected. Although an LED array is used as the optical writing device 25 in the present embodiment, a laser scanning device or the like may be appropriately selected.

Any device may be appropriately selected as the developing device 26 as long as it uses a developer as an image forming material, and in the present embodiment, the developing device 26 employs a two-component development method. The developing device 26 includes a development housing 261 having an opening facing the photoconductor 23, and a developing roller 262 disposed facing the opening of the development housing 261. The developing device 26 stores a two-component developer containing toner (including an external additive) and a carrier in the development housing 261. The developing device 26 agitates and conveys the developer by a pair of agitating/conveying members 263 so that the developer is carried on the developing roller 262 while charging the toner, and develops the electrostatic latent image on the photoconductor 23 with the toner. A collection member 264 returns the developer dropped from the developing roller 262 to the agitating/conveying member 263.

In the present embodiment, the photoconductor cleaning device 27 includes a cleaning housing 271 that is open so as to face the photoconductor 23, and an elastic plate-shaped cleaning member 272 is provided at an opening edge of the cleaning housing 271 with a support bracket 273. Here, the cleaning member 272 is disposed in such a manner that a leading end thereof comes into contact with the photoconductor 23 in a state of being inclined in a direction opposite to the rotation direction of the photoconductor 23, and scrapes residues remaining on the photoconductor 23 to clean the photoconductor 23. Further, a leveling/conveying member 274 is provided at the bottom of the cleaning housing 271 to level the residue accommodated in the cleaning housing 271 and to convey the residue to the outside of the cleaning housing 271 toward a collection container (not illustrated) at the time of disposal. A guide member 275 guides the residue scraped off by the cleaning member 272 toward the leveling/conveying member 274.

### <Intermediate Transfer Member>

The intermediate transfer member 30 is stretched around plural tension rollers 31 to 34, and for example, the tension roller 31 is used as a driving roller driven by a driving motor (not illustrated). The intermediate transfer member 30 is rotated by the driving roller.

In the present embodiment, the photoconductors 23 of the image forming units 22 are disposed so as to face the front surface of the intermediate transfer member 30 located between the tension rollers 31 and 32, and primary transfer devices 35 such as transfer rollers that electrostatically transfer the images G formed on the photoconductors 23 to the intermediate transfer member 30 are disposed on the back surface of the intermediate transfer member 30 facing the photoconductors 23.

### <Intermediate-Transfer-Member Cleaning Device>

Further, the intermediate transfer member 30 is provided with the intermediate-transfer-member cleaning device 36 on the surface located between the tension rollers 31 and 34. The intermediate-transfer-member cleaning device 36 removes residues such as residual toner and paper dust on the intermediate transfer member 30 after the transfer of the image to the medium S.

In the present embodiment, the intermediate-transfer-member cleaning device 36 is disposed at a position of the intermediate transfer member 30 closer to the tension roller 31 on the downstream side in the rotation direction with respect to the transfer region TR (corresponding to the position of the tension roller 34) of the transfer device 50 as illustrated in FIGS. 3 and 4B. The intermediate-transfer-member cleaning device 36 includes a cleaning housing 361 that is open so as to face the front surface of the intermediate transfer member 30, an elastic plate-shaped cleaning member 362 provided at the opening edge of the cleaning housing 361 with a support bracket 363, and a counter roller 364 provided on the back surface of the intermediate transfer member 30 facing the cleaning member 362. Here, the cleaning member 362 is disposed in such a manner that a leading end thereof comes into contact with the intermediate transfer member 30 in a state of being inclined in a direction opposite to the rotation direction of the intermediate transfer member 30, and scrapes residues remaining on the intermediate transfer member 30 to clean the intermediate transfer member 30. Further, the cleaning housing 361 includes a leveling/conveying member 365 that levels and conveys the accommodated residue, and a guide member 366 that guides the residue scraped off by the cleaning member 362 toward the leveling/conveying member 365. It is obvious that another type of cleaning member such as a cleaning brush may be provided instead of the plate-shaped cleaning member 362.

### <Necessity of Maintenance Process>

In the present embodiment, the photoconductor cleaning device 27 and the intermediate-transfer-member cleaning device 36 include plate-shaped cleaning members 272 and 362, respectively.

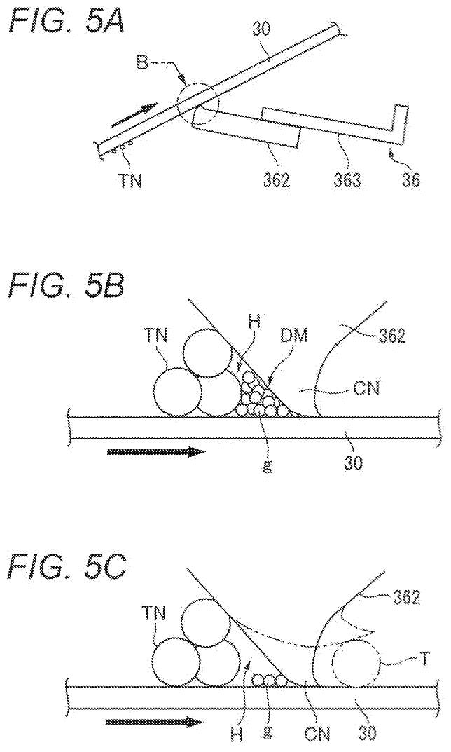

Taking the intermediate-transfer-member cleaning device 36 as an example, the cleaning member 362 is supported by the support bracket 363 in a cantilevered manner, and is disposed in a state of being inclined in a direction opposite to the moving direction (corresponding to the rotation direction) of the intermediate transfer member 30 as illustrated in FIGS. 5A and 5B. Therefore, the corner of the leading end of the cleaning member 362 on the free end side follows the moving direction of the intermediate transfer member 30 and comes into contact with the intermediate transfer member 30 in an elastically deformed state.

The residues such as toner remaining on the intermediate transfer member 30 are scraped off in the cleaning region by the cleaning member 362.

Meanwhile, the toner TN often includes an external additive g around toner particles obtained by kneading and pulverizing a colorant in a resin binder such as polyester. Microparticles of silica (SiO₂) such as colloidal silica, titanium oxide, alumina, or a fatty acid metal salt are used as the external additive g for the purpose of, for example, improving toner fluidity, adjusting an amount of triboelectric charge, and improving cleaning performance.

In this case, if a certain amount of residue such as toner remains on the intermediate transfer member 30, a certain amount of residue reaches the corner of the leading end of the cleaning member 362, so that a gap H between a contact portion CN of the cleaning member 362 and the intermediate transfer member 30 is filled with a dam DM constituted by the external additive g, and the residual toner TN can be dammed up by the dam DM constituted by the external additive g and scraped off, as illustrated in FIG. 5B.

In contrast, if the amount of the toner TN remaining on the intermediate transfer member 30 is extremely small when, for example, an image with a low printing rate is continuously printed, the external additive g does not form a dam in the gap H between the contact portion CN of the cleaning member 362 and the intermediate transfer member 30, so that the contact portion CN of the cleaning member 362 may have poor lubrication, and the remaining toner TN may pass through the contact portion CN of the cleaning member 362, as illustrated in FIG. 5C. In this case, the contact portion CN of the cleaning member 362 may be worn or the cleaning performance of the cleaning member 362 may be impaired.

For this reason, in the present embodiment, a maintenance process of maintaining the cleaning member 362 by regularly or irregularly replenishing the external additive g to the contact portion CN of the cleaning member 362 is needed in order to suppress wear of the cleaning member 362 and a cleaning failure by the cleaning member 362.

The above-described problem also occurs in the cleaning member 272 of the photoconductor cleaning device 27, and the maintenance device also performs the maintenance process on the cleaning member 272 of the photoconductor cleaning device 27.

The maintenance device that performs the maintenance process will be described later.

### —Transfer Device—

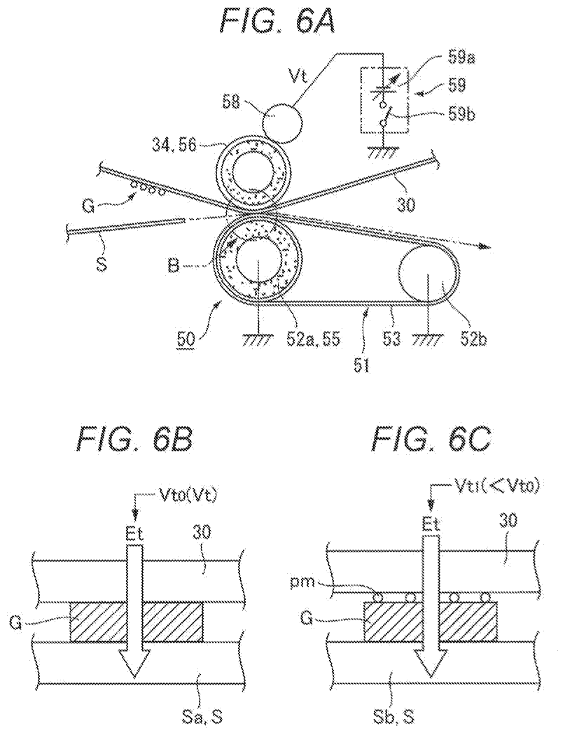

The transfer device 50 secondarily transfers the image G, which has been primarily transferred onto the intermediate transfer member 30, onto the medium S as illustrated in FIGS. 3 and 6A. In the present embodiment, the transfer device 50 includes a belt transfer module 51 obtained by stretching a transfer conveyance belt 53 around a plurality of tension rollers 52 (to be specific, 52a and 52b), the belt transfer module 51 being disposed so as to be in contact with the intermediate transfer member 30. The transfer conveyance belt 53 is a semiconductive belt formed of a material such as chloroprene and having a volume resistivity of 10⁶ to 10¹²Ω·cm. The tension roller 52a which is one of the tension rollers is formed as an elastic transfer roller 55. The elastic transfer roller 55 is disposed in pressure contact with the transfer region TR of the intermediate transfer member 30 with the transfer conveyance belt 53 therebetween, and the tension roller 34 of the intermediate transfer member 30 is disposed so as to face the elastic transfer roller 55 as a counter roller 56 serving as a counter electrode of the elastic transfer roller 55. The transfer conveyance belt 53 forms a conveyance passage for the medium S from the position of the tension roller 52a to the position of the tension roller 52b. In FIG. 3, a transfer cleaning device 57 cleans the transfer conveyance belt 53.

In the present embodiment, the elastic transfer roller 55 has a structure in which the periphery of a metal shaft is covered with an elastic layer obtained by mixing carbon black or the like with urethane foam rubber or EPDM. A transfer bias Vt from a transfer power source 59 is applied to the counter roller 56 (also serving as the tension roller 34 in the present embodiment) via a conductive power supply roller 58. The transfer power source 59 has a variable power source unit 59a and a switch unit 59b for turning on and off the variable power source unit 59a. On the other hand, the elastic transfer roller 55 (tension roller 52a) is grounded via a metal shaft (not illustrated), and as illustrated in FIG. 6B, a predetermined transfer electric field Et is formed between the elastic transfer roller 55 and the counter roller 56, so that the image G on the intermediate transfer member 30 is transferred to the medium S.

Note that the tension roller 52b is also grounded to prevent the transfer conveyance belt 53 from being charged. In addition, in consideration of the separation property of the medium S at the downstream end of the transfer conveyance belt 53, it is effective to set the diameter of the tension roller 52b on the downstream side to be smaller than the diameter of the tension roller 52a on the upstream side, because the tension roller 52b also serves as a separation roller.

### —Fixing Device—

The fixing device 70 includes a heat fixing roller 71 that is disposed in contact with the image-carrying surface of the medium S and that can be driven to rotate, and a pressure fixing roller 72 that is disposed in pressure contact with the heat fixing roller 71 so as to face the heat fixing roller 71 and rotates following the heat fixing roller 71. The fixing device 70 allows an image carried on the medium S to pass through a pressure-contact region between the two fixing rollers 71 and 72, thereby fixing the image by heat under pressure.

The fixing method performed by the fixing device 70 is not limited to the mode described in the embodiment, and a non-contact fixing method, a fixing method using a laser beam, or the like may be appropriately selected.

### —Medium Conveyance System—

The medium conveyance system 80 has, for example, one medium supply container 81 from which the medium S can be supplied. The medium conveyance system 80 conveys the medium S supplied from the medium supply container 81 to the transfer region TR through a vertical conveyance path 82 extending in a substantially vertical direction and a horizontal conveyance path 83 extending in a substantially horizontal direction, then, conveys the medium S carrying the transferred image to a fixing region by the fixing device 70 via a conveyance belt 84, and discharges the medium S to a medium discharge receiver (not illustrated) provided on a side of the device housing (not illustrated). In addition, the medium conveyance system 80 includes a position alignment roller 86 that aligns the position of the medium S and supplies the medium S to the transfer region TR, and further includes an appropriate number of conveyance rollers 87 in each of the conveyance paths 82 and 83.

In the present embodiment, the medium S is discharged from one medium supply container 81 to the medium discharge receiver (not illustrated) through the vertical conveyance path 82 and the horizontal conveyance path 83. However, the configuration is not limited thereto, and it is obvious that the design of the medium conveyance system 80 may be appropriately changed according to the specification of the image forming engine 21. Examples of changes of the medium conveyance system 80 include: a mode of using a plurality of medium supply containers 81; a mode in which a branch conveyance path that branches downward is provided at a section of the horizontal conveyance path 83 that is located downstream of the fixing device 70 in the medium conveyance direction, and a medium reversing mechanism is provided in the middle of the branch conveyance path to reverse and discharge the medium S into the medium discharge receiver; and a mode in which the medium S reversed by the above-described medium reversing mechanism is returned from the vertical conveyance path 82 to the horizontal conveyance path 83 through a return conveyance path (not illustrated), and an image is transferred onto the back surface of the medium S in the transfer region TR.

### —Microparticle Application Device—

### <Use of Microparticle Application Device>

In the present embodiment, the intermediate transfer member 30 is provided with a microparticle application device 100 that applies microparticles having excellent lubricity to the surface of the intermediate transfer member 30 as illustrated in FIG. 3.

The microparticle application device 100 is disposed, for example, at a portion of the intermediate transfer member 30 that is wound around the tension roller 31. When a predetermined microparticle application condition is satisfied, the microparticle application device 100 applies microparticles onto the intermediate transfer member 30 so that the image G is carried on a microparticle application layer.

Examples of the microparticle application condition include a condition that the medium S to be used is an embossed medium such as embossed paper having surface roughness (embossed surface).

In the present embodiment, when the medium S is an embossed medium, there is a concern that the image G carried on the intermediate transfer member 30 is not easily transferred to the embossed medium due to the influence of the surface roughness of the embossed medium, so that a transfer failure is likely to occur. In order to address such a situation, the present embodiment aims to improve, under an image forming condition using an embossed medium as the medium S, the transferability of the image G to the embossed medium in such a manner that an appropriate amount of microparticles are applied onto the intermediate transfer member 30, and the image G is carried on the microparticle application layer to reduce the adhesion force of the image G to the intermediate transfer member 30.

### —Microparticle—

In the present embodiment, the microparticles p may be appropriately selected as long as they have excellent lubricity. In the present embodiment, microparticles similar to those (for example, silica) that have already been used as an external additive of toner are used.

Examples of the reason why the material similar to the external additive of toner is used as the microparticle p as described above include the fact that the material is conventionally used as the external additive of toner and has high reliability, and the fact that, when the material is also used as the external additive, the material liberated from the toner is supplied to the intermediate transfer member 30, and thus the effect of the microparticle can be maintained more stably.

Examples of the material that can be used for the microparticle p include, in addition to silica, fine inorganic powders such as titanium oxide, alumina, barium titanate, calcium titanate, strontium titanate, zinc oxide, magnesium oxide, zirconium oxide, barium sulfate, barium carbonate, calcium carbonate, silicon carbide, silicon nitride, chromium oxide, or red iron oxide, and fine organic powders such as polyacrylate, polymethacrylate, polymethyl methacrylate, polyethylene, polypropylene, polyvinylidene fluoride, or polytetrafluoroethylene. In view of environmental stability, the microparticles desirably have low hygroscopic properties, and when fine hygroscopic inorganic powders such as titanium oxide, alumina, or silica are used, they are desirably subjected to a hydrophobic treatment. The hydrophobic treatment for the fine inorganic powder can be carried out by reacting the fine inorganic powder with a silane coupling agent such as hexamethyldisilazane, dimethyldichlorosilane, decylsilane, dialkyldihalogenated silane, trialkylhalogenated silane, or alkyltrihalogenated silane, or a hydrophobic treatment agent such as dimethyl silicon oil at a high temperature.

The particle diameter of the microparticles p may be appropriately selected according to the surface properties of the intermediate transfer member 30 on which the microparticles are to be applied. In the present embodiment, the microparticles p having a particle diameter in the range of 30 nm to 150 nm are selected for the intermediate transfer member 30 having a surface roughness Rz of 1.5 or less or a microgloss of 93 or more.

The selection of the microparticles p is based on the results of Examples described later.

### Configuration Example of Microparticle Application Device

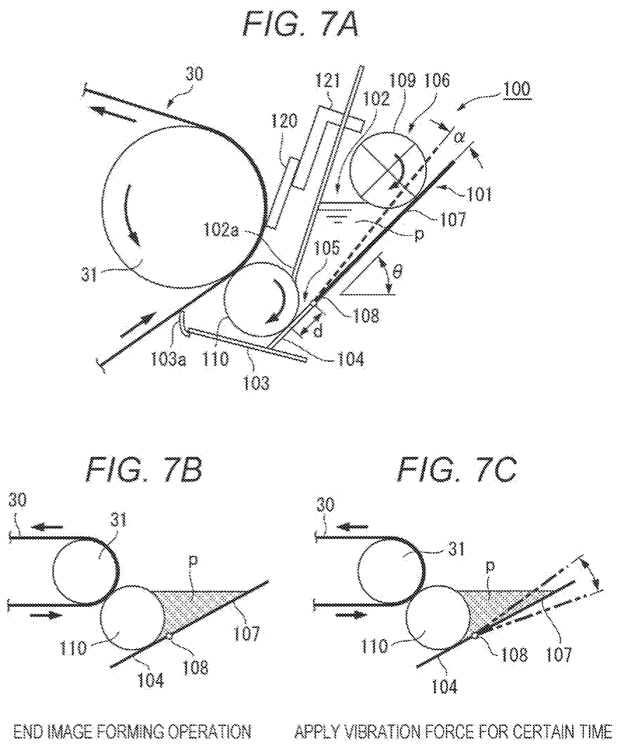

In the present embodiment, the microparticle application device 100 includes: an application container 101 that is opened to face a portion of the intermediate transfer member 30 wound around the tension roller 31; an application roller 110 that is disposed to face the opening of the application container 101 and is in contact with the intermediate transfer member 30 to apply the microparticles p; and a plate-shaped leveling member 120 that levels the application amount of a microparticle application layer pm applied on the intermediate transfer member 30 as illustrated in FIG. 7A.

The application container 101 includes a storage portion 102 for storing the powdery microparticles p and supplying the microparticles p to the application roller 110 from a lower opening, the storage portion 102 being provided above the application roller 110, a plate-shaped partition portion 103 provided below the application roller 110 so as to partition the space in the container, and a plate-shaped regulating portion 104 provided between the storage portion 102 and the partition portion 103 and disposed in contact with the application roller 110 on the side opposite to a contact portion with the intermediate transfer member 30.

In FIG. 7A, a sealing member 102a that is in elastic contact with the application roller 110 is provided at the edge of the lower opening of the storage portion 102, and a sealing member 103a that is in elastic contact with the intermediate transfer member 30 is provided at the end of the partitioning portion 103 on the intermediate transfer member 30 side.

### <Application Container>

In the present embodiment, a wedge-shaped gap 105 is formed between the application roller 110 and the regulating portion 104, and a filling mechanism 106 for filling the wedge-shaped gap 105 with the microparticles p is provided in a part of the storage portion 102. In the present embodiment, the storage portion 102 has a container side plate 107 that is contiguous to the regulating portion 104 and that is inclined like a slide at an angle θ of 45 degrees or more with respect to the horizontal direction. The filling mechanism 106 fills the wedge-shaped gap 105 with the microparticles p in such a manner that the container side plate 107 is supported so as to be swingable with respect to the regulating portion 104 with, for example, a hinge 108, a rotating paddle 109 serving as a swing means is disposed in contact with a portion of the container side plate 107 away from the hinge 108, and the container side plate 107 that is inclined like a slide is swung with the rotating paddle 109 at a predetermined angle α (for example, 10 degrees to 15 degrees).

Regarding the driving timing of the filling mechanism 106, the filling mechanism 106 may be driven, for example, in synchronization with the rotation of the application roller 110 when the microparticle application device 100 is driven, but it is preferable to maintain the state in which the wedge-shaped gap 105 is filled with the microparticles p when the driving of the microparticle application device 100 is started. In this case, it is only sufficient that, after the end of the image forming operation by the image forming system 20 as illustrated in FIG. 7B, for example, the filling mechanism 106 applies a vibration force to the container side plate 107 for a predetermined time to fill the wedge-shaped gap 105 with the microparticles p as illustrated in FIG. 7C.

The filling mechanism 106 is not limited to the rotating paddle 109, and may be appropriately changed in design. For example, the filling mechanism 106 may be configured such that a vibration motor (not illustrated) is directly or indirectly brought into contact with the outside of the container side plate 107 to propagate vibration, or such that the outside of the container side plate 107 is lifted by an eccentric cantilevered bar (not illustrated) and the cantilevered bar is rotated to repeat the contact and separation of the leading end of the cantilevered bar with the outside of the container side plate 107 to vibrate the container side plate 107.

### <Application Roller>

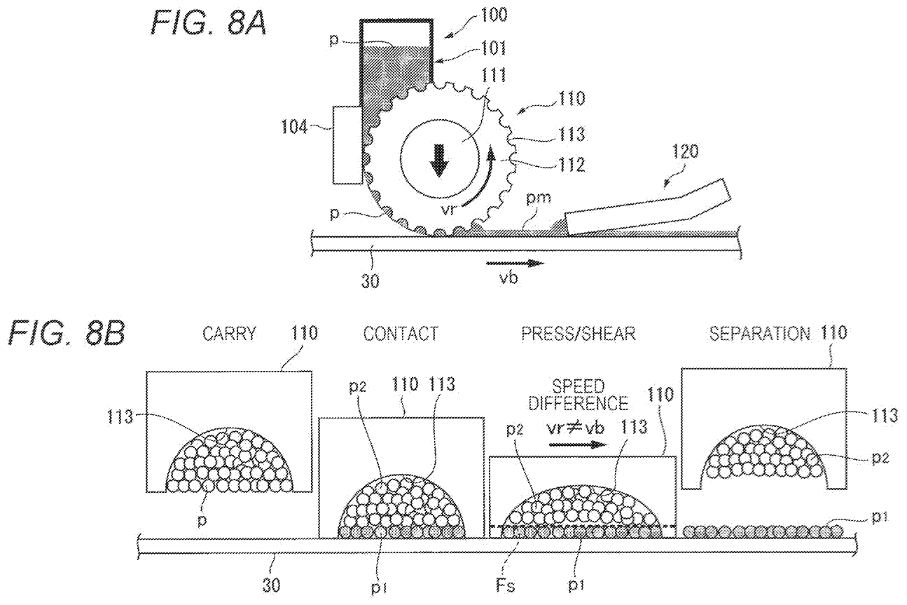

As illustrated in FIGS. 7A and 8A, the application roller 110 is an elastic roller having a large number of hemispherical recessed cells 113 on the surface thereof, and is produced by, for example, laminating an elastic layer 112 of urethane foam or the like around a metallic roller body 111 and forming many cells 113 on the surface of the elastic layer 112 by embossing.

In the present embodiment, it is sufficient that, since the cell 113 of the application roller 110 is required to carry the microparticles p therein, the cell has a diameter sufficiently larger than the particle diameter of the microparticles p, for example, 100 μm to 200 μm.

Further, in the present embodiment, the application roller 110 is disposed in elastic contact with the regulating portion 104 of the application container 101. The distance d between the contact portion between the application roller 110 and the regulating portion 104 and the support point of the container side plate 107 (corresponding to the supporting point of rotation of the hinge 108) is set to about 5 mm to 10 mm.

Further, the application roller 110 receives a driving force from a driving motor (not shown), and rotates in the same direction as the moving direction of the intermediate transfer member 30 at a portion facing the intermediate transfer member 30. In this case, establishment of vr≠vb is needed where the rotation speed of the application roller 110 is vr and the rotation speed of the intermediate transfer member 30 is vb.

The operation process of the application roller 110 will be schematically described below.

In the present embodiment, the application roller 110 is elastically pressed against the regulating portion 104 at the contact portion between the application roller 110 and the regulating portion 104. Thus, when the application roller 110 rotates with the microparticles p being filled in the wedge-shaped gap 105, the regulating portion 104 has an effect of leveling and putting the microparticles p into the cells 113 of the application roller 110 as illustrated in FIGS. 7A and 8A. As a result, a large number of microparticles p are filled and carried in the cells 113 of the application roller 110 which has passed through the regulating portion 104 as indicated by <CARRY> in FIG. 8B.

Next, when the cell 113 of the application roller 110 carrying the microparticles p reaches the contact portion with the intermediate transfer member 30, a group of microparticles p1 in the group of microparticles p in the cell 113 at the portion facing an inlet comes into contact with the intermediate transfer member 30 as indicated by <CONTACT> in FIG. 8B.

In this state, due to the speed difference between the rotation speed vr of the application roller 110 and the rotation speed vb of the intermediate transfer member 30, the group of microparticles p in the cell 113 is pressed against the intermediate transfer member 30, and the group of microparticles p1 in the group of microparticles p in the cell 113 at the position facing the inlet is going to adhere to the surface of the intermediate transfer member 30, as indicated by <PRESS/SHEAR> in FIG. 8B. Therefore, a shear force Fs associated with the speed difference acts on the boundary between the group of microparticles p1 in the cell 113 at the position facing the inlet and a group of the other microparticles p2, so that the group of microparticles p in the cell 113 is divided into two at the boundary.

Thereafter, when the cell 113 of the application roller 110 carrying the group of microparticles p passes through the contact portion with the intermediate transfer member 30, the cell 113 moves to a position apart from the surface of the intermediate transfer member 30 as indicated by <SEPARATION> in FIG. 8B. At this time, the group of microparticles p1 at a portion facing the inlet of the cell 113 is applied to the front surface of the intermediate transfer member 30 by the adhesion force, and the group of other microparticles p2 in the cell 113 remains carried in the cell 113.

### <Leveling Member>

In the present embodiment, the leveling member 120 is fixed to a part of the application container 101 with a support bracket 121 as illustrated in FIGS. 7A and 8A. The leveling member 120 is formed of an elastic plate-shaped member, and is disposed such that the leading end thereof is in contact with the intermediate transfer member 30 while being inclined in a direction opposite to the moving direction of the intermediate transfer member 30. In this configuration, the leveling member 120 needs to level the microparticle application layer pm applied on the intermediate transfer member 30 to a substantially uniform state, and to this end, an inclination angle β of the leveling member 120 with respect to the moving surface of the intermediate transfer member 30 is appropriately selected in a range of, for example, 5 degrees to 20 degrees. The inclination angle β is, for example, set to be smaller than the inclination angle of the cleaning member 362 of the intermediate-transfer-member cleaning device 36 so as to avoid excessive removal of the applied microparticles p.

As described above, in the present embodiment, the microparticle application layer pm applied on the intermediate transfer member 30 by the application roller 110 is substantially uniformly leveled by the leveling member 120.

### —Method for Detecting Application State of Microparticles—

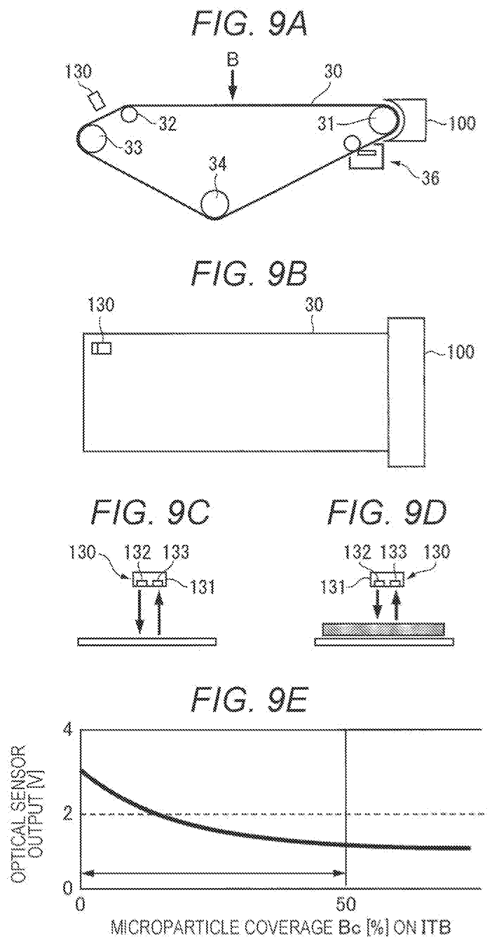

In the present embodiment, an optical sensor 130 is provided as a detection means for detecting the application state of the microparticles p on the intermediate transfer member 30. It is only sufficient that the optical sensor 130 is disposed so as to face the surface of the intermediate transfer member 30. For example, the optical sensor 130 is disposed near an end of the intermediate transfer member 30 in an intersecting direction that intersects the rotation direction of the intermediate transfer member 30 in a region between tension rollers 32 and 33 as illustrated in FIGS. 9A and 9B.

As illustrated in FIG. 9C, the optical sensor 130 includes, for example, a light emitting element 132 and a light receiving element 133 in a sensor housing 131. The optical sensor 130 irradiates the surface of the intermediate transfer member 30 with light from the light emitting element 132 and detects reflected light from the intermediate transfer member 30 by the light receiving element 133.

In the present embodiment, the optical sensor 130 detects the reflected light from the intermediate transfer member 30 with the light receiving element 133 in a state in which the microparticles p are not applied onto the intermediate transfer member 30 as illustrated in FIG. 9C. On the other hand, in a state in which the microparticles p are applied onto the intermediate transfer member 30, the optical sensor 130 detects the reflected light from the microparticle application layer pm on the intermediate transfer member 30 by the light receiving element 133 as illustrated in FIG. 9D.

Here, the relationship between a microparticle coverage Bc (%) on the intermediate transfer member 30 and an output (V) of the optical sensor 130 was examined, and the following tendency was observed. Note that the optical sensor 130 having a wavelength of 940 nm was used, and SiO₂ having a particle diameter of 115 nm was used as the microparticles.

In this case, as illustrated in FIG. 9E, the output of the optical sensor 130 has the maximum value when the microparticles p are not applied, and tends to gradually decrease as the microparticle coverage Bc increases. When the microparticle coverage Bc is 10% or more, the output of the optical sensor 130 is reduced to about ⅔ or less of the output when the microparticles p are not applied, and thus it is possible to clearly determine the state where the microparticles p are applied.

However, in the present embodiment, in a case where the microparticle coverage Bc exceeds 50%, the reduction rate of the output of the optical sensor 130 is extremely small, and the output of the optical sensor 130 has a value substantially the same as that in a case where the microparticle coverage Bc is 50%. This is presumed to be because, in a case where the microparticle coverage Bc increases, the reflection output decreases due to irregular reflection or a light confinement effect by the microparticles.

In the present embodiment, the output of the optical sensor 130 corresponds to the output of the light receiving element 133, and the microparticle coverage Bc means the occupancy of the microparticles p in a predetermined reference region for the microparticle application layer pm applied on the intermediate transfer member 30.

Therefore, in the present embodiment, since the output of the optical sensor 130 in a state where the microparticles p are applied is lower than the output of the optical sensor 130 in a state where the microparticles p are not applied, it is possible to determine whether or not the microparticles p are applied on the intermediate transfer member 30 by checking the output of the optical sensor 130.

In particular, when the microparticle application layer pm is formed, the microparticle coverage Bc is preferably selected in the range of 10% to 50% in consideration of the output characteristics of the optical sensor 130.

### —Relationship Between Microparticle Coverage and Toner Adhesion Force—

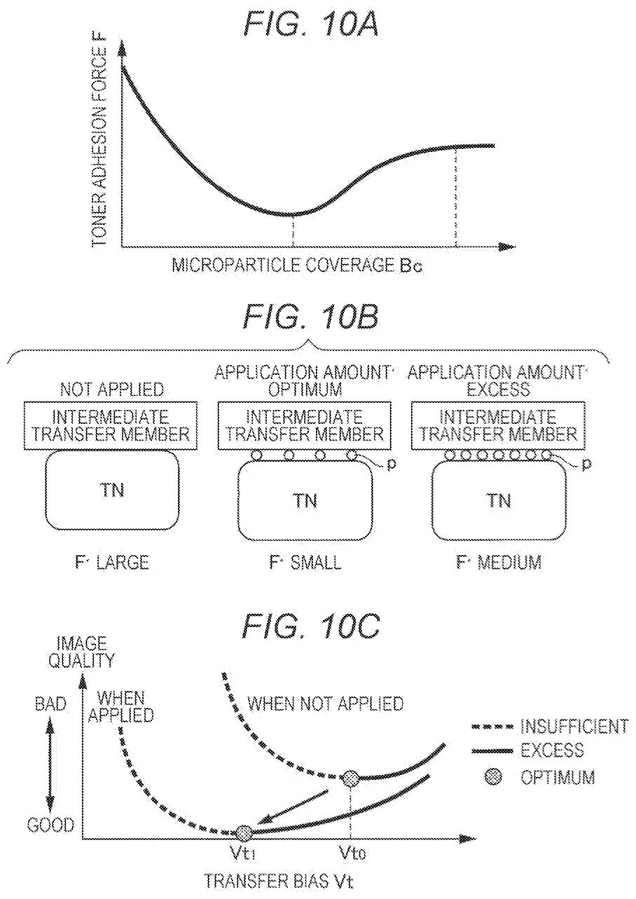

As a result of examining the relationship between the microparticle coverage Bc and the toner adhesion force F in the present embodiment, the toner adhesion force F is the largest when the microparticles are not applied and tends to gradually decrease with an increase in the microparticle coverage Bc until the microparticle coverage Bc reaches or exceeds a certain value, as illustrated in FIG. 10A. However, when the microparticle coverage Bc reaches or exceeds a certain value, the toner adhesion force F tends to increase again. This is presumed to be because, when the microparticle coverage Bc is equal to or greater than a certain value, the number of contact points between the microparticles p and toner TN increases, and the toner adhesion force F also increases with an increase in the van der Waals force, as indicated in the case of “application amount: excess” in FIG. 10B.

Therefore, in the present embodiment, the microparticle coverage Bc in the vicinity of the minimum value at which the toner adhesion force F becomes the lowest as illustrated in FIG. 10A is selected to optimize the application amount of the microparticles. Note that the microparticle coverage Bc different from the microparticle coverage Bc used in the present embodiment may be obviously selected.

### —Relationship Between Presence or Absence of Microparticles and Transfer Bias—

In the present embodiment, since the toner adhesion force F is different between when the microparticles are applied and when the microparticles are not applied, the transfer bias Vt of the transfer device 50 is selected so as to be different depending on whether or not the microparticles are applied.

For example, when the microparticles are not applied, the image G formed of the toner TN is carried on the intermediate transfer member 30 as illustrated in FIG. 6B. Here, when the image quality was examined by changing the transfer bias, the image quality was the best when the transfer bias Vt was Vt0, and the image quality tended to deteriorate when the transfer bias Vt was set higher or lower than Vt0 as illustrated in FIG. 10C.

When the microparticles p are applied with the predetermined microparticle coverage Bc, the image G formed of the toner TN is formed on the intermediate transfer member 30 with the microparticle application layer pm therebetween as illustrated in FIG. 6C. When the image quality was examined by changing the transfer bias, the image quality was the best when the transfer bias Vt was Vt1 (<Vt0), and the image quality tended to deteriorate when the transfer bias Vt was set higher or lower than Vt1. It is to be noted, however, that it was confirmed that even when the transfer bias Vt0 at the time when the microparticles were not applied was selected at the time when the microparticles were applied, the image quality was better than that at the time when the microparticles were not applied.

Therefore, the transfer bias Vt at the time when the microparticles are applied may be set to the same value as the transfer bias Vt0 at the time when the microparticles are not applied, but the transfer bias Vt1 at which the image quality is the best at the time when the microparticles are applied is selected.

### —Control System—

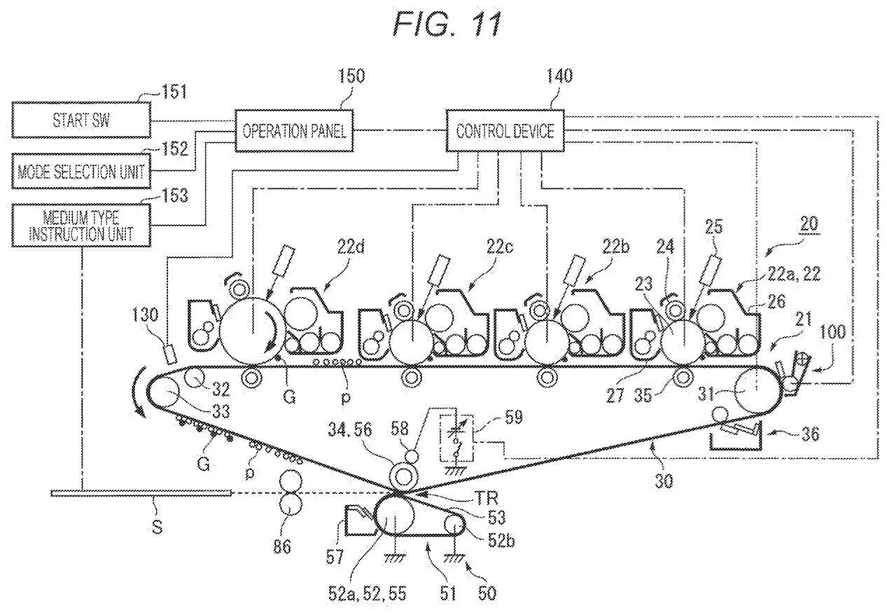

In the present embodiment, the control system of the image forming system 20 includes a control device 140 that is a microcomputer including various processors as illustrated in FIG. 11. The “processor” used herein refers to a processor in a broad sense, and includes a general-purpose processor (for example, central processing unit (CPU)) or a dedicated processor (for example, a graphics processing unit (GPU), an application specific integrated circuit (ASIC), a field programmable gate array (FPGA), or a programmable logic device).

An operation panel 150 and the optical sensor 130 of the image forming system 20 are connected to the control device 140. The control device 140 is connected to each control target (each image forming unit 22, the intermediate transfer member 30, a transfer power source 59 of the transfer device 50, the microparticle application device 100, and the like).

The operation panel 150 further includes a start switch (“start SW” in FIG. 11) 151 for starting image formation by the image forming system 20, a mode selection unit 152 for selecting one of various image forming modes (single-sided/double-sided printing mode, standard/high-quality printing mode, etc.), and a medium type instruction unit 153 for instructing the type (resistance, thickness, basis weight, size, whether or not embossing is performed, etc.) of the medium S. Regarding the type of the medium S, it is obvious that, for example, a detector which detects the type (resistance, thickness, size, whether or not embossing is performed, and the like) of the medium S may be installed in the medium supply container 81 or the conveyance path, and the type of the medium S may be acquired by the detector.

### —Image Forming Process of Image Forming System—

Next, a procedure of the image forming process performed by the image forming system according to the present embodiment will be described.

First, when the start switch 151 is turned on, the image forming system 20 starts a print job based on the image forming mode selected by the mode selection unit 152 as illustrated in FIG. 11. In this state, the medium S is supplied from the medium supply container 81. On the other hand, in the image forming unit 22, an image forming process for each color component image to be transferred to the medium S is performed, and the formed color component image moves to the transfer region TR via the intermediate transfer member 30.

Thereafter, the medium S is conveyed to the transfer region TR through the horizontal conveyance path 83, and a transfer operation is performed by the transfer device 50. Then, the medium S to which each color component image has been transferred passes through the fixing device 70, by which the image is fixed on the medium S.

### —Process of Microparticle Application Control—

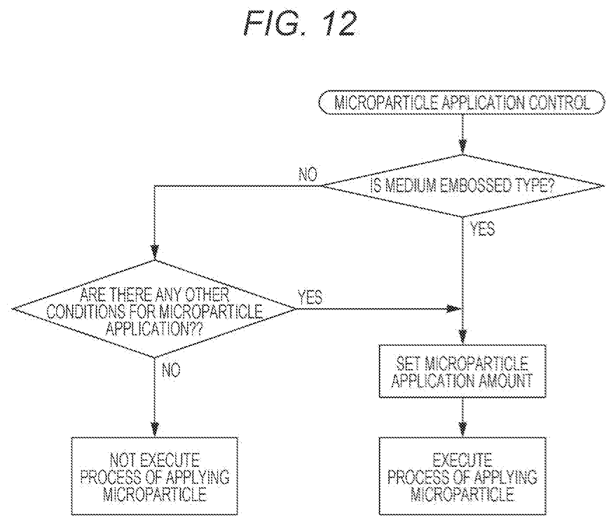

In the present embodiment, the control device 140 executes a microparticle application control program illustrated in FIG. 12 to control the operation of applying the microparticles p onto the intermediate transfer member 30.

In FIG. 12, first, the control device 140 determines whether or not the medium S is an embossed medium based on instruction information from the medium type instruction unit 153. Then, when the medium S is an embossed medium, the control device 140 sets a microparticle application amount, and executes the process of applying the microparticles p by the microparticle application device 100. Regarding setting of the microparticle application amount, the microparticle coverage Bc in the vicinity of the minimum value at which the toner adhesion force F becomes the lowest as illustrated in FIGS. 10A and 10B is selected in the present embodiment, although any value may be selected as appropriate.

When the medium S is not the embossed medium, it is determined whether or not there are any other conditions for microparticle application. When there are any other conditions for microparticle application, the control device 140 may set the microparticle application amount, and execute the process of applying the microparticles p. When there is no other condition for microparticle application, the control device 140 may not execute the process of applying the microparticles p.

Here, examples of the other conditions for microparticle application include a condition that rough paper or the like having a large amount of exposed paper fibers is used. In the present embodiment, the rough paper refers to, for example, paper (having roughness of about 10 μm to 30 μm) that has no roughness (about 30 μm or more) due to embossing and is rougher than electrophotographic paper.

### —Maintenance Control Process of Cleaning Device—

The control device 140 executes a cleaning-device maintenance control program illustrated in FIG. 12 to perform a maintenance process on the photoconductor cleaning device 27 and the intermediate-transfer-member cleaning device 36, thereby suppressing wear of the cleaning members 272 and 362 and cleaning failure by the cleaning members 272 and 362.

In FIG. 12, the control device 140 refers to information regarding the counted number of printed sheets and accumulation of image density to determine whether or not a condition requiring the maintenance process is established.

When the condition requiring the maintenance process is established, the control device 140 determines to execute the maintenance process. In contrast, when a condition not requiring the maintenance process is established, the control device 140 determines not to execute the maintenance process.

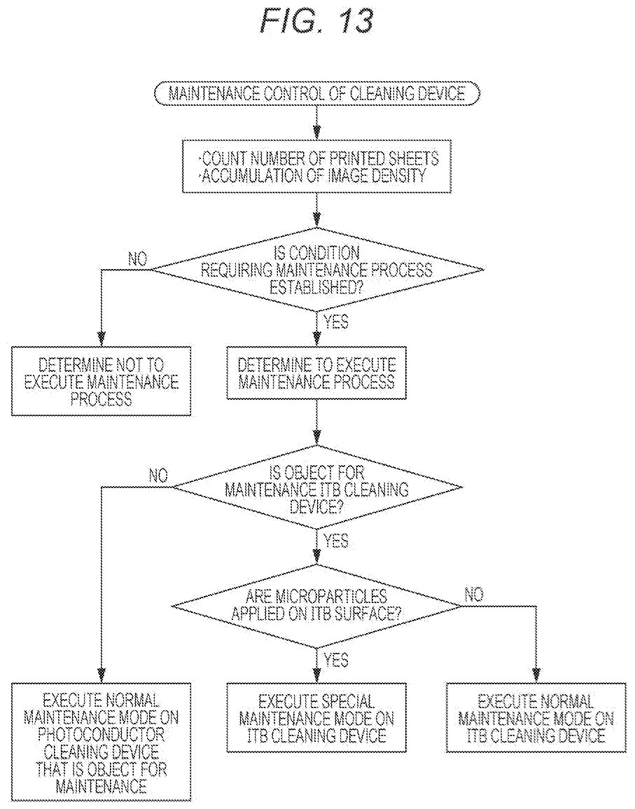

When determining to execute the maintenance process, the control device 140 identifies whether or not an object for maintenance is the intermediate-transfer-member cleaning device (illustrated as ITB cleaning device in FIG. 13) 36. When the object for maintenance is not the intermediate-transfer-member cleaning device 36, the control device 140 executes a normal maintenance mode on the photoconductor cleaning device 27 that is the object for maintenance.

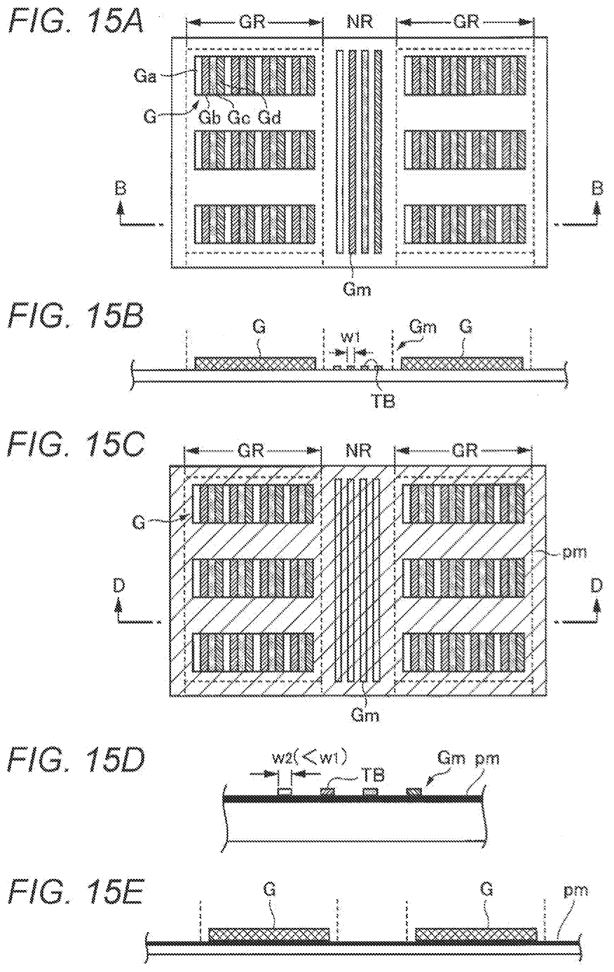

On the other hand, when the object for maintenance is the intermediate-transfer-member cleaning device 36, the control device 140 determines whether or not the microparticles p are applied on the surface of the intermediate transfer member 30 from the output of the optical sensor 130. When the microparticles p are not applied, the control device 140 executes the normal maintenance mode (see FIGS. 15A and 15B) on the intermediate-transfer-member cleaning device 36, and when the microparticles p are applied, the control device 140 executes a special maintenance mode on the intermediate-transfer-member cleaning device 36 (see FIGS. 15C to 15E).

### —Operation of Image Forming System—

### <Normal Image Forming Mode (Image Forming Mode I)>

In the present embodiment, the image forming system 20 performs a normal image forming mode (image forming mode I) under a condition that the microparticles p are not applied on the intermediate transfer member 30.

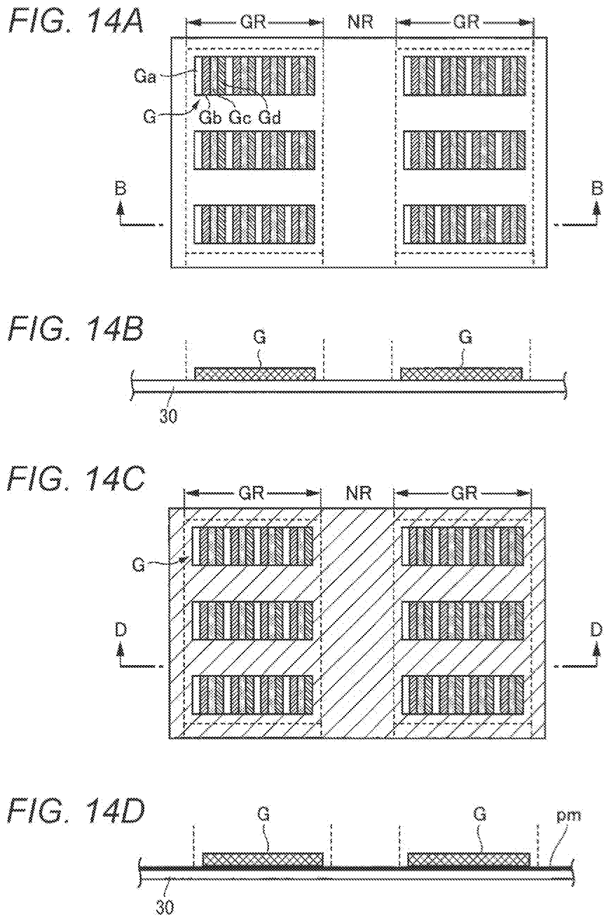

In the normal image forming mode (image forming mode I), the images G (to be specific, Ga to Gd) of the respective color components formed by the image forming units 22 (22a to 22d) are sequentially primarily transferred to the respective image formation regions GR on the intermediate transfer member 30, and are secondarily transferred to the medium S in the transfer region TR as illustrated in FIGS. 11, 14A, and 14B. In FIG. 14A, the image formation regions GR are discontinuously arranged with the non-image formation region NR therebetween. In addition, the image G of each color component is an image in which image elements of each color component are repeatedly described in a ladder pattern shape, and this schematically illustrates an image including the image elements of each color component. The same applies to FIG. 14C and FIGS. 15A and 15C.

### <Special Image Forming Mode (Image Forming Mode II)>

In the present embodiment, the image forming system 20 performs a special image forming mode (image forming mode II) obtained by adding an application process of applying the microparticles p to the normal image forming mode under a condition that the microparticles p are to be applied on the intermediate transfer member 30.

In the special image forming mode (image forming mode II), the microparticle application device 100 applies the microparticles p to the entire region including the image formation regions GR and the non-image formation regions NR on the intermediate transfer member 30 according to a predetermined microparticle coverage Bc, and then the image forming units 22 (22a to 22d) sequentially primarily transfer the images G of the color components to the image formation regions GR of the intermediate transfer member 30 as illustrated in FIGS. 11, 14C, and 14D. Therefore, the image G of each color component produced by the corresponding image forming unit 22 is carried on the microparticle application layer pm on the intermediate transfer member 30, and is secondarily transferred to the medium S (the embossed medium Sb in the present embodiment) in the transfer region TR.

At this time, the image G of each color component is carried on the intermediate transfer member 30 with the microparticle application layer pm therebetween, and thus, is easily transferred to the embossed medium Sb(S). Accordingly, the image G of each color component is appropriately transferred without being affected by the roughness of the embossed medium Sb.

In particular, in the present embodiment, the transfer bias Vt used in the transfer device 50 is changed to the transfer bias Vt1 that is optimum for the transfer condition when the microparticles are applied instead of the transfer bias Vt0 which is used during the normal image forming mode, and thus, it is possible to obtain image transferability of higher image quality than that in the case of using the transfer bias Vt0.

In the present embodiment, the control device 140 functions as a maintenance device serving as a maintenance means.

### <Normal Maintenance Mode (Maintenance Mode I)>

Under the condition that the microparticles p are not applied onto the intermediate transfer member 30, the control device 140 performs the normal maintenance mode (maintenance mode I) as illustrated in FIGS. 11, 14, 15A, and 15B.

In the present embodiment, when a condition that requires the maintenance process on the predetermined cleaning members 272 and 362 is established, the control device 140 uses necessary devices (the charging device 24, the optical writing device 25, and the developing device 26) of each image forming unit 22 to form a maintenance image Gm on an entire region or a part of each photoconductor 23 and supplies the maintenance image Gm to the cleaning members 272 and 362 to be maintained.

Here, examples of the condition requiring the maintenance process include a condition that an amount of toner remaining on the photoconductor 23 or the intermediate transfer member 30 is reduced to such an extent that the cleaning operation by the cleaning members 272 and 362 is impaired. This condition may be determined based on whether or not the accumulated image forming conditions and print number conditions of the print job reach a predetermined threshold.

The maintenance image Gm is produced separately from the normal image G and is supplied based on an amount required for the maintenance process of the cleaning members 272 and 362. Since the maintenance image Gm is formed using developer in each developing device 26, the maintenance image Gm has a shape pattern that does not wastefully consume the developer. In the present embodiment, the maintenance image Gm is formed as one or a plurality of band-shaped images (corresponding to so-called toner bands) TB continuously extending along an intersecting direction (for example, a width direction) intersecting the rotation direction of the photoconductor 23 or the intermediate transfer member 30. The thickness, width, image density Cin, number, and the like of the band-shaped image TB may be appropriately selected. For example, the thickness, width, image density Cin, number, and the like of the band-shaped image TB may be appropriately selected in consideration of the configuration of, for example, one band-shaped image TB having a thickness equivalent to the thickness of a normal toner image (for example, 6 μm to 10 μm), a width of about 1 mm to 3 mm, and an image density Cin of about 50% to 100%.

Although the maintenance image Gm carried on the intermediate transfer member 30 includes the band-shaped images TB of all the color components of the image forming units 22 (22a to 22d) in FIGS. 15A and 15A, the maintenance image Gm does not necessarily include the band-shaped images TB of all the color components and may include the band-shaped images TB of some of the color components.

In addition, it is only sufficient that the maintenance image Gm is formed over the entire width of the image formation region GR of the photoconductor 23 or the intermediate transfer member 30. The maintenance image Gm is not limited to be continuously formed over the entire area of the image formation region GR in the width direction, and a plurality of divided band-shaped images may be discontinuously formed to cover the entire area of the image formation region GR in the width direction.

Furthermore, in the present embodiment, the image forming system 20 is configured to be able to execute the maintenance mode in parallel with the image forming mode, so that the maintenance image Gm is basically formed in the non-image formation region NR other than the image formation region GR. In the maintenance process for the photoconductor cleaning device 27, the maintenance image Gm in the non-image formation region (not illustrated) on the photoconductor 23 is supplied to the photoconductor cleaning device 27 without being transferred to the intermediate transfer member 30. On the other hand, in the maintenance process for the intermediate-transfer-member cleaning device 36, the maintenance image Gm formed on the photoconductor 23 is transferred to the non-image formation region NR on the intermediate transfer member 30, and then is supplied to the intermediate-transfer-member cleaning device 36 without being transferred to the medium S.

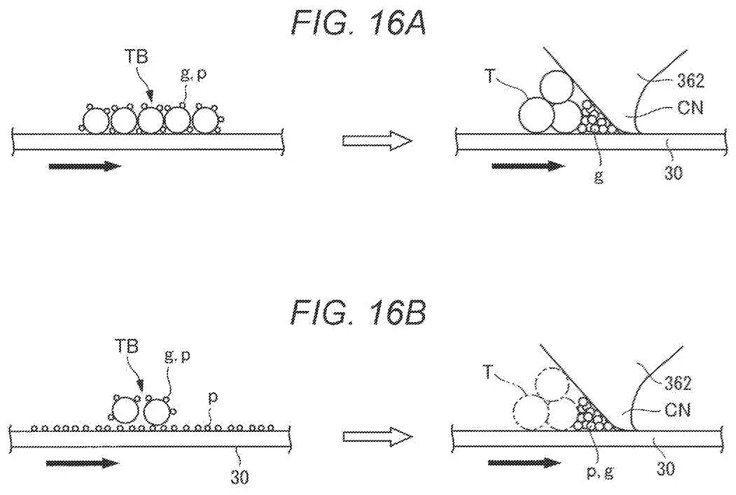

As described above, in the normal maintenance mode (maintenance mode I), the maintenance image Gm is forcibly supplied to the contact portion of the cleaning members 272 and 362, so that a large amount of the external additive g included in the maintenance image Gm is supplied to the contact portion of the cleaning members 272 and 362 and accumulated as a dam DM, as illustrated in FIG. 16A. Accordingly, the contact state between the contact portion of the cleaning member 272 and the photoconductor 23 and between the contact portion of the cleaning member 362 and the intermediate transfer member 30 is satisfactorily maintained, and the maintenance process for the cleaning members 272 and 362 is completed.

### <Special Maintenance Mode (Maintenance Mode II)>

Under the condition that the microparticles p are to be applied onto the intermediate transfer member 30, the control device 140 performs the special maintenance mode (maintenance mode II) on the intermediate-transfer-member cleaning device 36 as illustrated in FIGS. 11, 14, 15C, and 15D. Note that, in the present embodiment, only the normal maintenance mode I is executed for the photoconductor cleaning device 27.

In the special maintenance mode (maintenance mode II), the control device 140 forms the maintenance image Gm as in the normal maintenance mode (maintenance mode I), but the width w2 of the band-shaped image TB as the maintenance image Gm is set to be smaller than the width w1 in the normal maintenance mode I. For this reason, the consumption amount of toner used for the maintenance image Gm is reduced.

Therefore, in the present embodiment, the maintenance image Gm is carried on the intermediate transfer member 30 on which the microparticle application layer pm is applied, and the maintenance image Gm and the microparticle application layer pm are forcibly supplied to the contact portion of the cleaning member 362 as illustrated in FIG. 16B. At this time, the consumption amount of toner constituting the maintenance image Gm is smaller than that in the normal maintenance mode, and thus, the amount of the external additive g included in the maintenance image Gm is also small. However, the microparticles p included in the microparticle application layer pm compensate for the amount of the external additive g. Therefore, a large amount of the external additive g and the microparticles p equivalent to the external additive g are supplied to the contact portion of the cleaning member 362 and accumulated as the dam DM. Thus, the contact state between the contact portion of the cleaning member 362 and the intermediate transfer member 30 is maintained satisfactorily, and the maintenance process for the cleaning member 362 is completed.

### Another Example of Special Maintenance Mode (Maintenance Mode II)

As another example of the special maintenance mode (maintenance mode II), it is also possible to use only the microparticle application layer pm as a substitute for the maintenance image without forming the maintenance image Gm in the maintenance process for the intermediate-transfer-member cleaning device 36, as illustrated in FIG. 15E. When the special image forming mode (image forming mode II) is executed, the microparticle application layer pm has already been formed on the intermediate transfer member 30, and therefore, the microparticle application layer pm may be used as a substitute for the maintenance image. In addition, the microparticle application layer pm is not formed on the intermediate transfer member 30 during the execution of the normal image forming mode (image forming mode I). Therefore, when the special maintenance mode is performed, the microparticle application device 100 may be operated to form the microparticle application layer pm only in the non-image formation region NR on the intermediate transfer member 30, and the formed microparticle application layer pm may be used as the maintenance image.

### Another Configuration Example of Microparticle Application Device

In the present embodiment, the microparticle application device 100, for example, is not limited to have the configuration described in the first embodiment, and it is obvious that the microparticle application device 100 may be changed in design, as appropriate, as in, for example, modification 1-1 or modification 1-2.

### ⊙ Modification 1-1

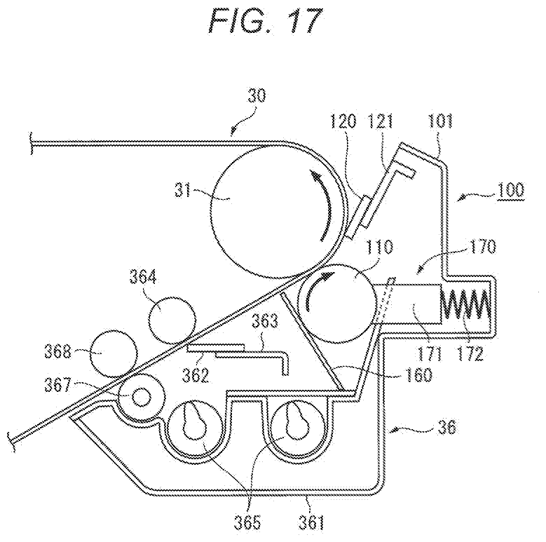

FIG. 17 illustrates a microparticle application device according to the modification 1-1.

In FIG. 17, the microparticle application device 100 has a configuration different from that of the first embodiment, and is integrally incorporated in the intermediate-transfer-member cleaning device 36.

In the present modification, the intermediate-transfer-member cleaning device 36 is provided in the vicinity of the tension roller 31 of the intermediate transfer member 30 on the upstream side of the tension roller 31 in the rotation direction. The intermediate-transfer-member cleaning device 36 includes a cleaning housing 361 that is open so as to face the front surface of the intermediate transfer member 30, an elastic plate-shaped cleaning member 362 provided at the opening edge of the cleaning housing 361 with a support bracket 363, and a counter roller 364 provided on the back surface of the intermediate transfer member 30 facing the cleaning member 362. Furthermore, in the present modification, the cleaning housing 361 includes, in the lower portion thereof, a pair of leveling/conveying members 365 that levels and coveys the stored residues, and a brush-shaped second cleaning member 367 provided upstream of the plate-shaped cleaning member 362 in the rotation direction of the intermediate transfer member 30. A counter roller 368 is provided on the back surface of the intermediate transfer member 30 facing the second cleaning member 367.

The microparticle application device 100 is incorporated in an upper portion of the cleaning housing 361 of the intermediate-transfer-member cleaning device 36.

As in the first embodiment, the microparticle application device 100 according to the present modification includes: an application container 101 that is opened to face a portion of the intermediate transfer member 30 wound around the tension roller 31; an application roller 110 that is disposed to face the opening of the application container 101 and is in contact with the intermediate transfer member 30 to apply the microparticles p; a plate-shaped leveling member 120 that levels the application amount of the microparticle application layer pm applied on the intermediate transfer member 30; and a microparticle attaching mechanism 170 that attaches the microparticles p to the surface of the application roller 110.

In the present modification, unlike the first embodiment, the application container 101 is integrally formed in the upper portion of the cleaning housing 361, and has a partition member 160 between the application roller 110 and the cleaning member 362. The application roller 110 has substantially the same configuration as that in the first embodiment. In addition, the leveling member 120 is supported at the upper edge of the opening of the application container 101 with a support bracket 121, and has substantially the same configuration as that of the first embodiment.

In particular, in the present modification, the microparticle attaching mechanism 170 is configured such that a block-shaped microparticle solid mass 171 produced by compression molding of a large number of microparticles is brought into contact with the application roller 110 on the side opposite to the contact portion with the intermediate transfer member 30, and is pressed against the surface of the application roller 110 by a pressure spring 172 as a pressing means. According to the microparticle attaching mechanism 170, the microparticles p are scraped off from the microparticle solid mass 171 at a contact portion between the application roller 110 and the microparticle solid mass 171 with the rotation of the application roller 110, are leveled and filled into the recessed cells (not shown) of the application roller 110, and are attached to the surface of the application roller 110.

As a result, the application roller 110 reaches the contact portion with the intermediate transfer member 30 in a state of carrying the microparticles p on the surface thereof, and after being applied to the surface of the intermediate transfer member 30, the microparticles p are leveled to a predetermined application amount by the leveling member 120. In the present modification, even if some of the scraped microparticles p drop from the contact portion between the microparticle solid mass 171 and the application roller 110, they are accumulated in a space partitioned by the partition member 160.

Further, in the present modification, the microparticle application device 100 does not include the application container 101 described in the first embodiment (the storage portion 102 for storing powdery microparticles, the wedge-shaped gap 105 formed between the application roller 110 and the regulating portion 104, and the filling mechanism 106), but may use the application container 101 described in the first embodiment. Specifically, instead of the powdery microparticles p, the microparticle solid mass 171 (see FIG. 17) may be disposed in the storage portion 102 so as to be in contact with the application roller 110 or a scraping roller (not illustrated) provided separately from the application roller 110, the microparticles p may be scraped from the microparticle solid mass 171 by the application roller 110 or the scraping roller, and the wedge-shaped gap 105 may be filled with the scraped powdery microparticles p.

⊙ Modification 1-2

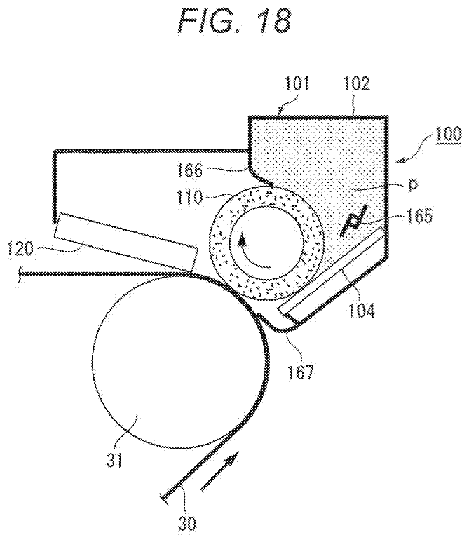

FIG. 18 illustrates a microparticle application device according to the modification 1-2.

In FIG. 18, the microparticle application device 100 includes an application container 101 for storing powdery microparticles p, an application roller 110 for applying the microparticles p to the intermediate transfer member 30, and a leveling member 120 for leveling the microparticle application layer pm applied to the intermediate transfer member 30 as in the first embodiment, but differs from the first embodiment in the layout of the application roller 110 and the leveling member 120 and the method for attaching the microparticles p to the application roller 110.

In the present modification, the application roller 110 and the leveling member 120 are disposed above a portion of the intermediate transfer member 30 which is stretched around the tension roller 31.

Further, the application container 101 includes a storage portion 102 that is open so as to cover the right half surface of the application roller 110 in FIG. 18 and that stores the powdery microparticles p, a regulating portion 104 that is disposed in the storage portion 102 so as to be in contact with the application roller 110 in the vicinity of the lower portion of the application roller 110, and a wedge-shaped gap 105 formed between the regulating portion 104 and the application roller 110. An agitator 165 serving as an agitation member that agitates the accumulated microparticles p is provided above the wedge-shaped gap 105 in the storage portion 102. An upper sealing member 166 that elastically comes into contact with the upper portion of the application roller 110 for sealing is provided at the upper edge of the opening of the storage portion 102 of the application container 101, and a lower sealing member 167 that elastically comes into contact with the surface of the intermediate transfer member 30 for sealing is provided at the lower edge of the opening of the storage portion 102.

As described above, according to the present modification, when the microparticles p are applied to the intermediate transfer member 30, the application roller 110 and the agitator 165 may be rotated along with the rotation of the intermediate transfer member 30. At this time, in the storage portion 102 of the application container 101, the microparticles p in the storage portion 102 are filled in the wedge-shaped gap 105 by the rotation of the agitator 165, and when the application roller 110 rotates in this state, the microparticles p are leveled and filled into the cells (not illustrated) of the application roller 110 by the regulating portion 104 at the contact portion between the application roller 110 and the regulating portion 104. As a result, the application roller 110 reaches the contact portion with the intermediate transfer member 30 in a state of carrying the microparticles p on the surface thereof, and after being applied to the surface of the intermediate transfer member 30, the microparticles p are leveled to a predetermined application amount by the leveling member 120.

### Θ Second Embodiment

An image forming system 20 according to the second embodiment is obtained by applying the aspect of the present invention to a mode in which an amount of microparticles applied to the intermediate transfer member 30 is changed in a plurality of stages, and basically has the same configuration as that of the first embodiment. However, the image forming system 20 is different from the first embodiment in control of applying microparticles to the intermediate transfer member 30 and the maintenance control of the intermediate-transfer-member cleaning device 36.

### —Process of Microparticle Application Control—

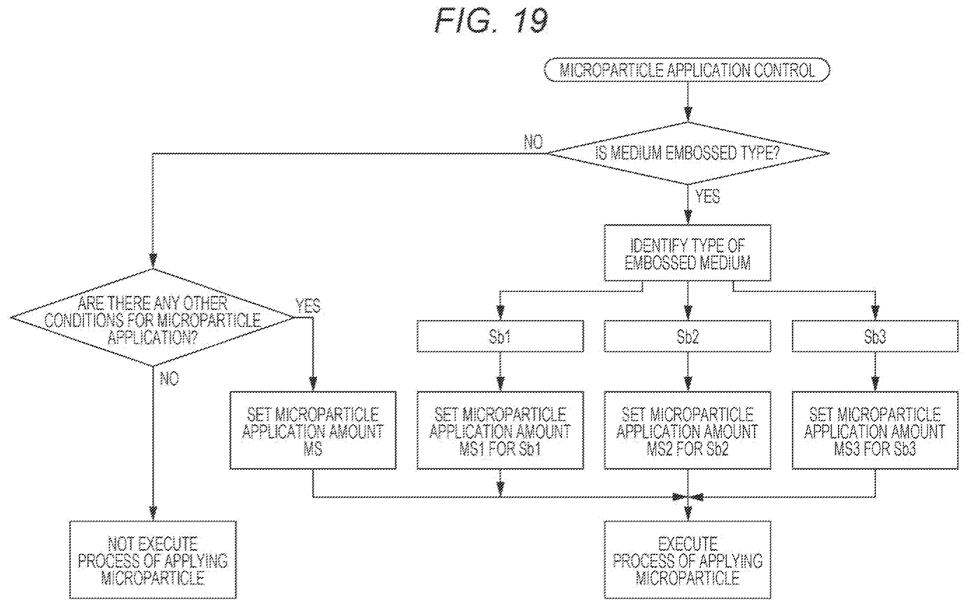

In the present embodiment, the control device 140 (see FIG. 11) executes a microparticle application control program illustrated in FIG. 19 to control the operation of applying the microparticles p onto the intermediate transfer member 30.

In FIG. 19, first, the control device 140 determines whether or not the medium S is an embossed medium based on the instruction information from the medium type instruction unit 153 (see FIG. 11). In the determination process, when there are a plurality of types of embossed media depending on the depth, size, and the like of embossing, the types (for example, Sb1, Sb2, and Sb3) are identified.

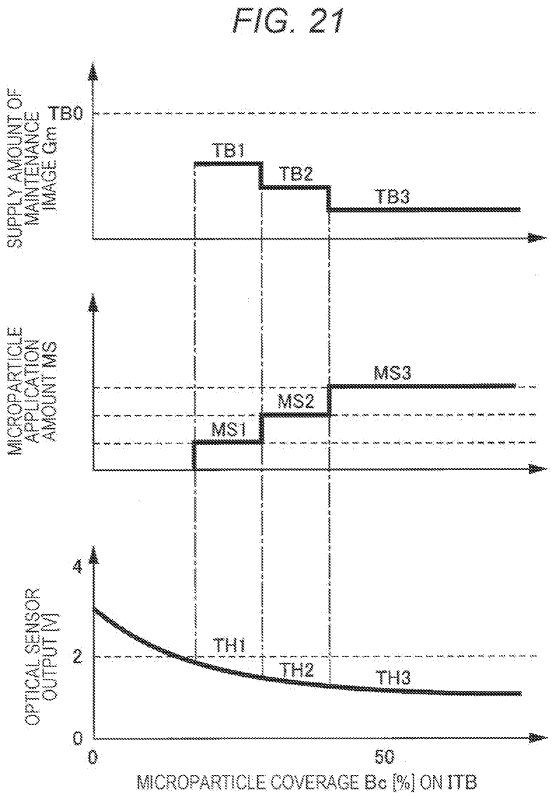

In a case where the medium S is an embossed medium, a microparticle application amount MS (MS1, MS2, MS3) is set according to the type (Sb1, Sb2, Sb3) of the embossed medium, and the process of applying the microparticles p by the microparticle application device 100 is performed. Here, the microparticle application amount MS may be appropriately set, but in the present embodiment, the microparticle application amount MS is set to satisfy the relationship of MS1<MS2<MS3 on the basis of the microparticle coverage Bc on the intermediate transfer member 30 as illustrated in FIG. 21.

In order to change the microparticle application amount MS, the application amount to the intermediate transfer member 30 by the application roller 110 may be changed by, for example, changing the rotation speed vr of the application roller 110 with respect to the rotation speed vb of the intermediate transfer member 30 to change the speed difference.

When the medium S is not the embossed medium, it is determined whether or not there are any other conditions for microparticle application. When there are any other conditions for microparticle application, the control device 140 may set the microparticle application amount, and execute the process of applying the microparticles p. When there is no other condition for microparticle application, the control device 140 may not execute the process of applying the microparticles p.

### —Maintenance Control Process of Intermediate-Transfer-Member Cleaning Device—

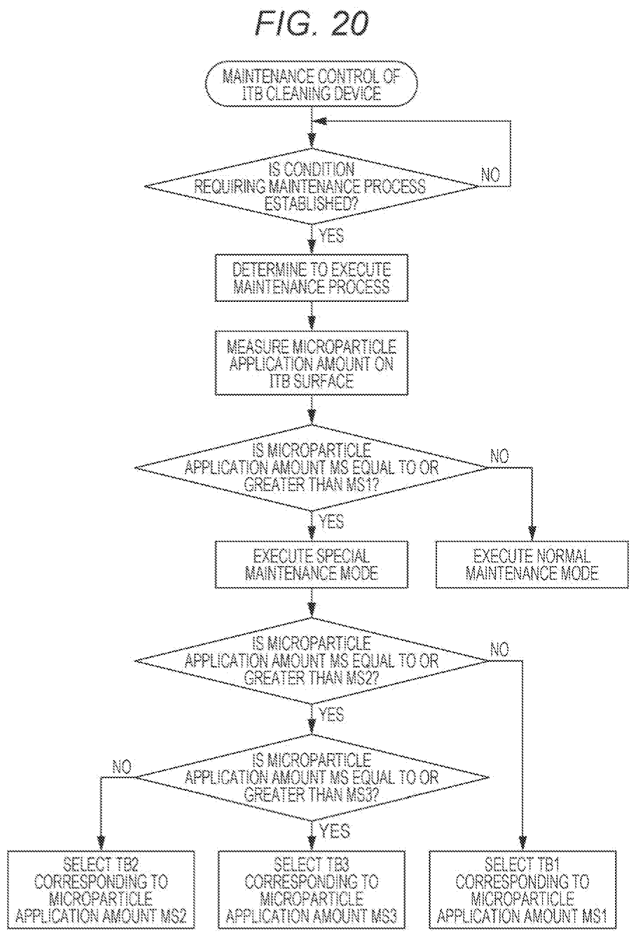

The control device 140 (see FIG. 11) executes a program for maintenance control of the intermediate-transfer-member cleaning device illustrated in FIG. 20 to perform a maintenance process on the intermediate-transfer-member cleaning device 36, thereby suppressing wear of the cleaning member 362 and cleaning failure by the cleaning member 362. Note that the maintenance process in the normal maintenance mode is executed on the photoconductor cleaning device 27 in substantially the same manner as in the first embodiment.

In FIG. 20, the control device 140 refers to information regarding the counted number of printed sheets and accumulation of image density to determine whether or not a condition requiring the maintenance process is established. When a condition requiring the maintenance process is established, the control device 140 determines to execute the maintenance process.

When determining to execute the maintenance process, the control device 140 determines whether or not the microparticles p are applied on the surface of the intermediate transfer member 30 from the output of the optical sensor 130 (see FIG. 9). When the microparticles p are not applied, the control device 140 executes the normal maintenance mode (see FIGS. 15A and 15B) on the intermediate-transfer-member cleaning device 36. In the present embodiment, when the output of the optical sensor 130 is less than a threshold TH1 corresponding to the microparticle application amount MS1, it is assumed that the microparticles p are not applied.

On the other hand, when the microparticles p are applied, the special maintenance mode is performed on the intermediate-transfer-member cleaning device 36 (see FIGS. 15C to 15E).

The thresholds for the output of the optical sensor 130 corresponding to the microparticle application amounts MS1, MS2, and MS3 are defined as TH1, TH2, and TH3, respectively. In the present embodiment, when the output of the optical sensor 130 is equal to or greater than the threshold TH1 and less than the threshold TH2, a band-shaped image TB1 corresponding to the microparticle application amount MS1 is selected as the maintenance image Gm as illustrated in FIGS. 20 and 21. When the output of the optical sensor 130 is equal to or greater than the threshold TH2 and less than the threshold TH3, a band-shaped image TB2 corresponding to the microparticle application amount MS2 is selected as the maintenance image Gm. Further, when the output of the optical sensor 130 is equal to or greater than the threshold TH3, a band-shaped image TB3 corresponding to the microparticle application amount MS3 is selected as the maintenance image Gm.

Given that the band-shaped image when the microparticles are not applied is defined as TB0, the relationship of TB0>TB1>TB2>TB3 is satisfied as illustrated in FIG. 21 regarding the supply amount of the maintenance image Gm.

As described above, in the special maintenance mode in the present embodiment, control is performed so that an amount of the maintenance image varies depending on the application amount of the microparticles under the condition that the microparticles are applied, with an amount of the maintenance image in the normal maintenance mode under the condition that the microparticles are not applied being defined as an upper limit.

More specifically, in the special maintenance mode, an amount of the maintenance image is controlled to be smaller as the application amount of the microparticles is larger under the condition that the microparticles are applied. In other words, in the special maintenance mode, an amount of the maintenance image is controlled to be larger as the application amount of the microparticles is smaller under the condition that the microparticles are applied.

Therefore, in the present embodiment, when the maintenance process is performed on the intermediate-transfer-member cleaning device 36 in a mode in which the application amount of the microparticles on the intermediate transfer member 30 varies, the amount of the maintenance image can be limited as much as possible by effectively using the microparticle application layer pm applied on the intermediate transfer member 30, as compared with the case where the application amount of the microparticles is uniformly determined.

Although the microparticle application amount MS is changed stepwise in the present embodiment, it is obvious that, for example, the microparticle application amount may be continuously changed in accordance with the change curve of the microparticle coverage as illustrated in FIG. 21, and an amount of the maintenance image in the special maintenance mode may be selected on the basis of the change.

### ⊙ Third Embodiment

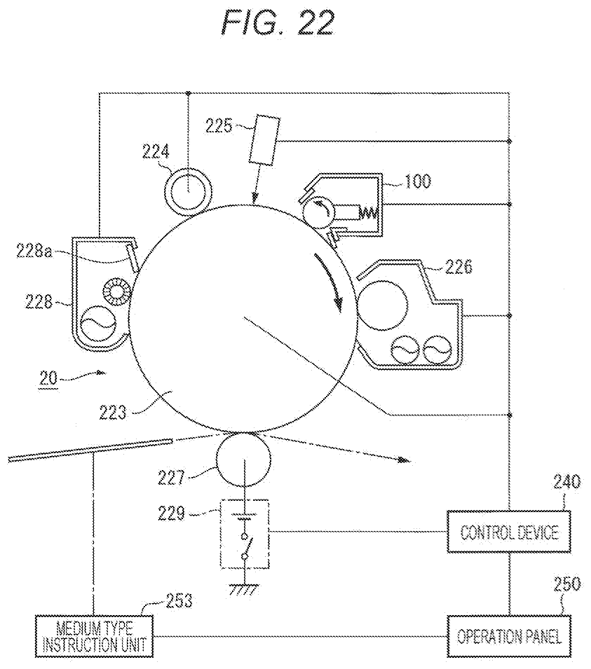

FIG. 22 illustrates a main part of an image forming system according to a third embodiment.

Unlike the first and second embodiments, the image forming system 20 forms a single-color image with, for example, black toner in FIG. 22.

In FIG. 22, the image forming system 20 employs, for example, an electrophotographic method, and includes a drum-shaped photoconductor 223. The image forming system 20 includes, around the photoconductor 223, a charging device 224 that charges the photoconductor 223, an optical writing device 225 that writes an electrostatic latent image on the charged photoconductor 223, a developing device 226 that develops the electrostatic latent image written on the photoconductor 223 with toners of respective color components, a transfer device 227 that transfers the toner image formed on the photoconductor 223 onto a medium S, and a cleaning device 228 (including a plate-shaped cleaning member 228a) that cleans off toner TN remaining on the photoconductor 223.

In the present embodiment, a microparticle application device 100 is provided between the optical writing device 225 and the developing device 226 in the periphery of the photoconductor 223, and microparticles are applied onto the photoconductor 223 in a case where the medium S is, for example, an embossed medium.

In the present embodiment, an operation panel 250 is connected to a control device 240, and a medium type instruction unit 253 and the like are connected to the operation panel 250. In addition to a normal image forming control process, the control device 240 performs a microparticle application control process on the photoconductor 223, a maintenance control process on the cleaning device 228, and the like, and appropriately controls the photoconductor 223 and each device around the photoconductor 223.

The image forming system 20 includes a transfer power source 229 of the transfer device 227.

In the present embodiment, the control device 240 performs control of application of microparticles onto the photoconductor 223, and performs a maintenance process (normal maintenance process, special maintenance process) on the cleaning device 228 depending on the application state of the microparticles. The normal maintenance process and the special maintenance process are performed in substantially the same manner as those described in the first and second embodiments.

Although the image forming system in the present embodiment forms a single-color image, the image forming system 20 according to the present embodiment may be applied to, for example, an image forming system in which image forming units 22 (22a to 22d, see FIG. 3) of respective color components are arranged so as to face a medium conveyance belt that conveys the medium S.

### Example

In this example, a device based on Revoria Press PC1120 manufactured by FUJIFILM Business Innovation Corp. was used. The evaluation environment is 22° C./55%, and the process speed is 524 mm/s. Regarding toner, YMC each have a specific gravity of 1.1 and a particle diameter of 4.7 μm, and K has a specific gravity of 1.2 and a particle diameter of 4.7 μm. The toner mass per area (TMA) of YMC was set to 3.3 g/m² and the TMA of K was set to 3.7 g/m². The primary transfer device 35 was an elastic roller with φ28 having a volume resistance of 7.7 log Ω and an Asker C hardness of 30°. The primary transfer current was set to 54 μA. As the intermediate transfer member 30, an intermediate transfer belt obtained by dispersing carbon in polyimide was used, the intermediate transfer belt having a volume resistivity of 12.5 log Ωcm. The intermediate-transfer-member cleaning device 36 has, as a cleaning member, a plate-shaped cleaning blade made of urethane rubber and having a thickness of 2 mm, the cleaning blade being in contact with the surface of the intermediate transfer belt at a setting angle of 22° and a linear pressure of 2.3 gf/mm.

The transfer device 50 employed a belt transfer module 51 in which a rubber belt with φ40 having a thickness of 450 μm and a volume resistance of 9.2 log Ω as the transfer conveyance belt 53 was wound around the elastic transfer roller 55 with ϕ28 having a volume resistance of 6.3 log Ω and was stretched between the elastic transfer roller 55 and a separation roller with φ20. An elastic roller with φ28 having an Asker C hardness of 53° and a surface resistance of 7.3 log Ω/□ was used as the counter roller 56 provided via the intermediate transfer member 30.

Further, as the microparticles, SiO₂ having a particle diameter of 115 nm was used, and as the application roller 110, a urethane sponge roller with φ28 having an Asker C hardness of 15° was used. The urethane sponge roller carrying the microparticles was brought into contact with the intermediate transfer member 30 with an amount of bite of 0.5 mm and rotated at a peripheral speed ratio of 1.5 with respect to the intermediate transfer member 30, thereby applying the microparticles onto the surface of the intermediate transfer member 30. The amount of microparticles applied to the intermediate transfer member 30 was adjusted by the amount of microparticles carried by the urethane sponge roller.

### —Relationship Between Application Amount of Microparticles and Amount of Maintenance Image—

J paper (non-coated paper, 82 gsm) manufactured by FUJIFILM Business Innovation Corp. was used as a medium, and cleaning failure for the intermediate transfer member when image/non-image charts illustrated in FIGS. 15A and 15A, for example, were output in 1kpv on the J paper was checked by changing the application amount of microparticles and the amount of toner band that is a band-shaped image as the maintenance image.

Specifically, the application amount of microparticles was classified into “microparticles not applied, 0%”, “microparticles applied with coverage of 10%”, and “microparticles applied with coverage of 40%”, and the amount of toner band was classified into “no band”, “band of 1%”, “band of 4%”, and “band of 10%”.

Here, the amount of toner band (wt %) is per color, and is a value obtained by conversion with a case where a single color is solidly printed on all over the surface of A4 paper being defined as 100%.

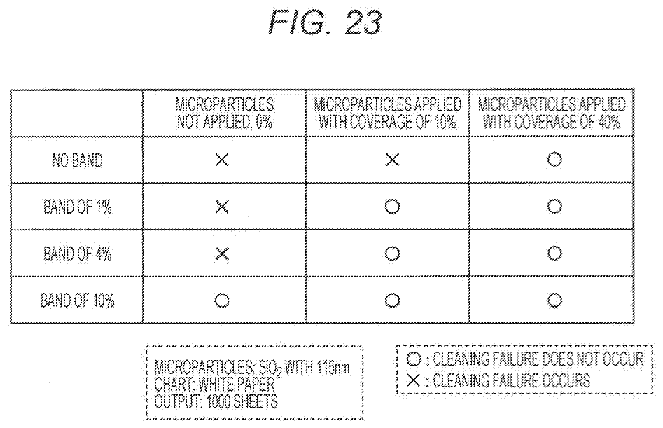

The results are shown in FIG. 23.

FIG. 23 suggests that, as the application amount of microparticles increases, the cleaning failure can be suppressed even when the amount of toner band is small.

### —Relationship Between Particle Diameter of Microparticles, Toner Adhesion Force, and Image Transferability—

When the microparticles are applied onto the intermediate transfer member 30 according to the present example, the surface roughness of the microparticle application layer changes depending on the particle diameter of the microparticles.

The used intermediate transfer belt had a surface roughness Rz of 1.5 or less or a microgloss of 93 or more when the surface property of the intermediate transfer member 30 on which the microparticles were not applied was measured.

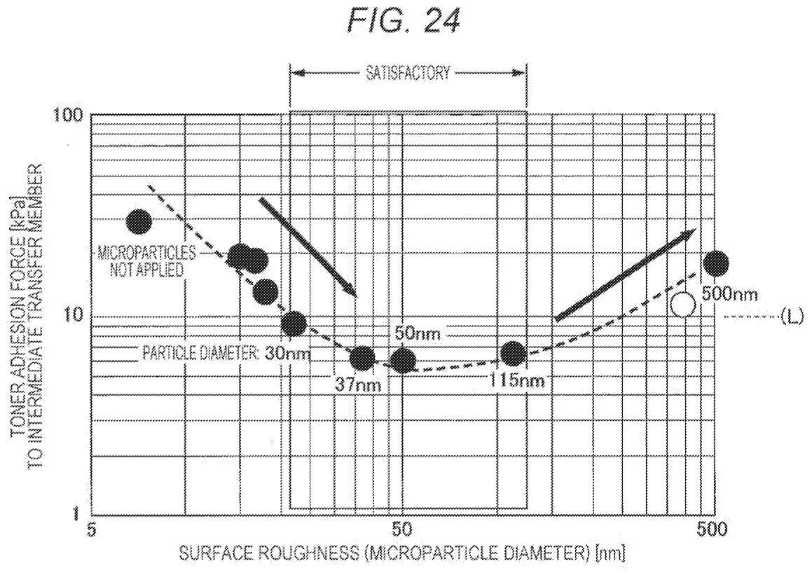

The relationship between the surface roughness (corresponding to the particle diameter of the microparticles) [nm] of the microparticle application layer and the toner adhesion force to the surface of the intermediate transfer member 30 (hereinafter referred to as toner adhesion force) [kPa] was examined, and the results shown in FIG. 24 were obtained. Here, the toner adhesion force is expressed as follows. Specifically, compressed air is blown from a glass nozzle to the toner layer on the surface of the intermediate transfer member 30 while increasing the pressure, and the air pressure at the timing at which the toner layer is separated is used as the adhesion force (alternative characteristic).

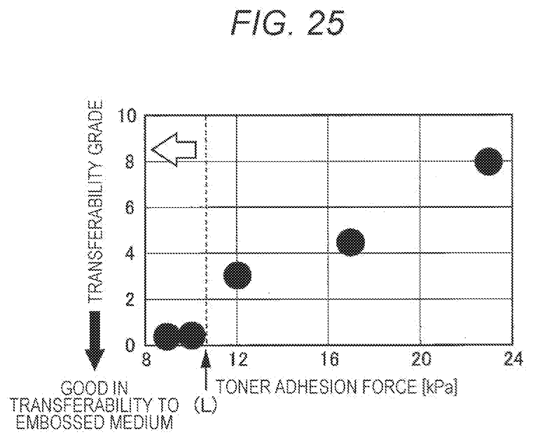

Further, based on the results shown in FIG. 24, the relationship between the toner adhesion force [kPa] and the transferability grade was examined, and the results shown in FIG. 25 were obtained. Here, the transferability grade is obtained in such a manner that the microparticle application layer corresponding to the toner adhesion force is applied on the intermediate transfer belt, a predetermined image/non-image chart is carried on the microparticle application layer, and image quality when the chart is transferred to embossed paper as an embossed medium is visually checked. The smaller the numerical value of the transferability grade, the better the transferability to the embossed medium.

It is understood from FIG. 25 that, when the toner adhesion force is equal to or less than a predetermined threshold L (in this example, 10 kPa is selected), the transferability grade with respect to embossed medium is good.

It is understood from FIG. 24 that, when the particle diameter range of the microparticles having the toner adhesion force equal to or less than the threshold L (10 kPa) is examined, the particle diameter range from 30 nm to 115 nm is preferable.

Thus, it is understood that the main effect of the microparticle application is to reduce the adhesion force between the toner and the surface of the intermediate transfer member 30 and improve the image transferability.

It is to be noted, however, that the particle diameter of the microparticles is preferably selected in an appropriate range from 30 nm to 115 nm.

The microparticles within the appropriate range have a size that allows the microparticles to enter the gap H (see FIG. 5B) between the contact portion of the cleaning member 362 of the intermediate-transfer-member cleaning device 36 and the intermediate transfer member 30, and therefore have an effect of preventing a cleaning failure. On the other hand, when the particle diameter of the microparticles is large, the microparticles do not enter the gap H between the contact portion of the cleaning member 362 and the intermediate transfer member 30, and thus, do not provide the effect of preventing a cleaning failure. When the particle diameter of the microparticles is smaller than 30 nm, the microparticles p that have entered the gap H easily pass through the contact portion, and the amount of microparticles passing through the contact portion increases. This destabilizes the contact state, and also allows toner TN to pass through, and thus, not preferable.

### —Relationship Between Particle Diameter of Microparticles and Amount of Maintenance Image—

As in the above case, cleaning failure for the intermediate transfer member when the image/non-image charts were output on J paper (non-coated paper, 82 gsm) in 1kpv was checked by changing the particle diameter of the microparticles and the amount of toner band that is a band-shaped image as the maintenance image.

To be specific, the particle diameter of the microparticles was classified into “microparticles not applied”, “SiO₂ with 500 nm applied”, “SiO₂ with 100 nm applied”, and “SiO₂ with 37 nm applied”, and the amount of toner band was classified into “no band”, “band of 1%”, “band of 4%”, and “band of 10%”.

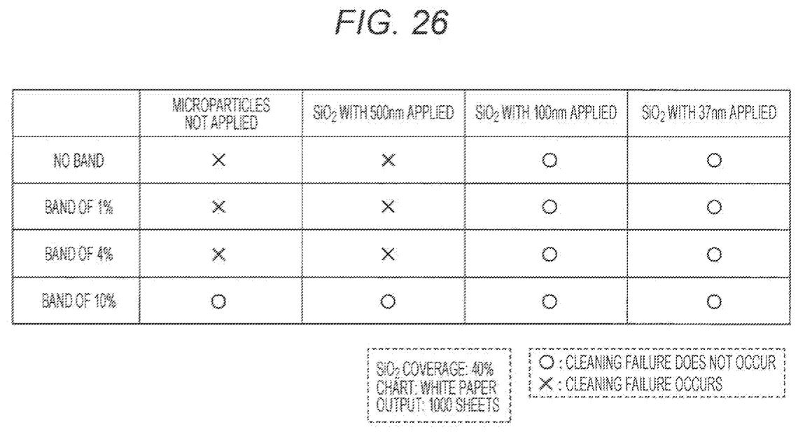

The results are shown in FIG. 26.

It is suggested that, when the microparticles SiO₂ having a particle diameter in the range of 30 nm to 115 nm and having a good transferability grade are used, the effect of reducing the amount of toner band is observed with respect to the case where the microparticles are not applied, but the effect is not observed when the particle diameter size is increased.

### (Supplementary Matter)

(((1))

An image forming system comprising: an image carrying element that is rotatably provided and carries an image; an image forming element that forms the image on the image carrying element using an image forming material containing at least an external additive; a transfer element that transfers the image carried by the image carrying element to a medium; a cleaning element having a plate shape, the cleaning element being disposed so that a leading end comes into contact with the image carrying element while being inclined in a direction opposite to a rotation direction of the image carrying element to clean a residue remaining on the image carrying element after a transfer operation by the transfer element; a maintenance element that forms, using the image forming element, a band-shaped maintenance image of the image forming material in a non-image formation region of the image carrying element, and regularly or irregularly supplies the maintenance image to the cleaning element in a state where the transfer operation by the transfer element is not performed; a microparticle application element that regularly or irregularly applies a microparticle having lubricity to the image carrying element; and a maintenance control element that controls an amount of the maintenance image by the maintenance element depending on an application state of the microparticle on the image carrying element.

(((2)))

The image forming system according to (((1))), wherein the maintenance control element performs control so that the amount of the maintenance image by the maintenance element differs between under a condition that the microparticle is applied and under a condition that the microparticle is not applied, with the amount of the maintenance image by the maintenance element under the condition that the microparticle is not applied being defined as an upper limit.

(((3)))

The image forming system according to (((2))), wherein the maintenance control element performs control so that the amount of the maintenance image is smaller under the condition that the microparticle is applied than the amount of the maintenance image under the condition that the microparticle is not applied.

(((4)))

The image forming system according to (((2))) or (((3))), wherein the maintenance control element performs control so that the maintenance image is not supplied under the condition that the microparticle is applied.

((5)

The image forming system according to (((1))), wherein the maintenance control element performs control so that the amount of the maintenance image varies depending on an application amount of the microparticle under a condition that the microparticle is applied, with the amount of the maintenance image by the maintenance element under a condition that the microparticle is not applied being defined as an upper limit.

(((6)))

The image forming system according to (((5))), wherein the maintenance control element performs control so that the amount of the maintenance image is smaller as the application amount of the microparticle is larger under the condition that the microparticle is applied.

(((7)))

The image forming system according to (((5))), wherein the maintenance control element performs control so that the amount of the maintenance image is larger as the application amount of the microparticle is smaller under the condition that the microparticle is applied.

(((8)))

The image forming system according to any one of (((1))) to (((7))), wherein the maintenance control element includes a detection element capable of detecting an application state of the microparticle, and controls the amount of the maintenance image on the basis of a detection result of the detection element.

(((9)))

The image forming system according to (((8))), wherein the detection element includes a reflective optical sensor disposed facing an application layer of the microparticle.

(((10)))

The image forming system according to any one of (((1))) to (((9))), wherein the microparticle application element applies the microparticle having a particle diameter within a range of 30 nm to 150 nm onto the image carrying element having a surface roughness Rz of 1.5 or less or a microgloss of 93 or more.

(((11)))

The image forming system according to (((10))), wherein the microparticle application element applies the microparticle to the image carrying element with a coverage in a range of 10% to 50%.

What is claimed is:

1. An image forming system comprising:
an image carrying element that is rotatably provided and carries an image;
an image forming element that forms the image on the image carrying element using an image forming material containing at least an external additive;
a transfer element that transfers the image carried by the image carrying element to a medium;
a cleaning element having a plate shape, the cleaning element being disposed so that a leading end comes into contact with the image carrying element while being inclined in a direction opposite to a rotation direction of the image carrying element to clean a residue remaining on the image carrying element after a transfer operation by the transfer element;
a maintenance element that forms, using the image forming element, a band-shaped maintenance image of the image forming material in a non-image formation region of the image carrying element, and regularly or irregularly supplies the maintenance image to the cleaning element in a state where the transfer operation by the transfer element is not performed;
a microparticle application element that regularly or irregularly applies a microparticle having lubricity to the image carrying element; and
a maintenance control element that controls an amount of the maintenance image by the maintenance element depending on an application state of the microparticle on the image carrying element.

2. The image forming system according to claim 1, wherein
the maintenance control element performs control so that the amount of the maintenance image by the maintenance element differs between under a condition that the microparticle is applied and under a condition that the microparticle is not applied, with the amount of the maintenance image by the maintenance element under the condition that the microparticle is not applied being defined as an upper limit.

3. The image forming system according to claim 2, wherein
the maintenance control element performs control so that the amount of the maintenance image is smaller under the condition that the microparticle is applied than the amount of the maintenance image under the condition that the microparticle is not applied.

4. The image forming system according to claim 2, wherein
the maintenance control element performs control so that the maintenance image is not supplied under the condition that the microparticle is applied.

5. The image forming system according to claim 1, wherein
the maintenance control element performs control so that the amount of the maintenance image varies depending on an application amount of the microparticle under a condition that the microparticle is applied, with the amount of the maintenance image by the maintenance element under a condition that the microparticle is not applied being defined as an upper limit.

6. The image forming system according to claim 5, wherein
the maintenance control element performs control so that the amount of the maintenance image is smaller as the application amount of the microparticle is larger under the condition that the microparticle is applied.

7. The image forming system according to claim 5, wherein
the maintenance control element performs control so that the amount of the maintenance image is larger as the application amount of the microparticle is smaller under the condition that the microparticle is applied.

8. The image forming system according to claim 1, wherein
the maintenance control element includes a detection element capable of detecting an application state of the microparticle, and controls the amount of the maintenance image on the basis of a detection result of the detection element.

9. The image forming system according to claim 8, wherein
the detection element includes a reflective optical sensor disposed facing an application layer of the microparticle.

10. The image forming system according to claim 1, wherein
the microparticle application element applies the microparticle having a particle diameter within a range of 30 nm to 150 nm onto the image carrying element having a surface roughness Rz of 1.5 or less or a microgloss of 93 or more.

11. The image forming system according to claim 10, wherein
the microparticle application element applies the microparticle to the image carrying element with a coverage in a range of 10% to 50%.
